(19) United States
(12) Patent Application Publication
(10) Pub. No.: US 2023/0306953 A1
(43) Pub. Date: Sep. 28, 2023

(54) METHOD FOR GENERATING A REVERBERATION AUDIO SIGNAL

(71) Applicant: LIQUID OXIGEN (LOX) B.V., Amsterdam (NL)

(72) Inventor: Paulus Oomen, Amsterdam (NL)

(21) Appl. No.: 18/023,295

(22) PCT Filed: Aug. 26, 2021
(86) PCT No.: PCT/NL2021/050523

§ 371 Date: Feb. 24, 2023

(30) Foreign Application Priority Data
Aug. 28, 2020 (NL) 2026361

(51) Int. Cl. G10K 15/08; H04S 7/00

(52) U.S. Cl. CPC G10K 15/08; H04S 7/307; H04S 7/305; H04S 7/302; H04S 2400/11

(57) ABSTRACT

Generating a reverberation audio signal associated with a virtual object comprises storing a representation of the virtual object defining a plurality of virtual points constituting the virtual object that have respective virtual positions with respect to each other, and belong to symmetry groups of virtual points, which is associated with a set of symmetry group distance(s), which sets are respectively associated with symmetry groups, together forming a further set of distance(s) An input audio signal is obtained, and, for each virtual point, a virtual point audio signal component is determined, the virtual point audio signal components are combined to obtain a composite audio signal. Each, distinct distance in the further set of one or more distances is determined based on the composite audio signal and distance audio signals j., The reverberation audio signal is based on the distance audio signal(s) and the virtual point audio signal components.

### FIELD OF THE INVENTION

This disclosure relates systems and methods for generating a reverberation audio signal.

### BACKGROUND

Problems of reproducing accurate and perceptually convincing sound reverberation are generally known.

When we consider the requirements for acoustically simulating e.g. a concert hall and we suppose we would only need the response of the acoustical space at one discrete listening point, i.e. one ear of a listener, due to one discrete point source of acoustic energy. The direct signal propagating from a sound source to a listener's ear can be simulated using a single delay line in series with an attenuation scaling or low-pass filter. Second, each sound ray arriving at the listening point via one or more reflections can be simulated using a delay-line and some scale factor or filter. More generally, a tapped delay line can simulate many reflections. Each tap brings out one echo at an appropriate delay and gain, and each tap can be independently filtered to simulate air absorption and reflections loss. In principle, tapped delay lines can accurately simulate any reverberant environment, because reverberation really does consist of many paths of acoustic propagation from each source to each listening point (Smith, 1993).

The approach to simulation appears to be straight-forward, as does its fundamental problems, because i) tapped delay lines are relatively computationally expensive relative to other techniques, such as signal attenuation of signal path distribution, and ii) each tapped line handles only one ‘point-to-point’ transfer function, i.e., from one point source to one ear, whereas one needs many, and each point-to-point transfer should be changed when a source and/or listener moves, or anything else in the room changes.

The problem further increases when considering that each echo can be perceived as coming from a particular angle of arrival in a 3-dimensional space. At least some reverberation reflections should be spatialized, i.e. distributed across spatially configured loudspeaker channels or filtered taking the head-related transfer function (HRTF) of the ear's pinnae into account e.g., so that the reflections appear to come from their natural directions (Kendall, Martens, 1984). Hence, the spatialization should also change if anything changes in the listening space, including source or listener position.

For music, a typical reverberation time is in the order of one second. Suppose we choose exactly one second for the reverberation time. At an audio sampling rate of 50 kHz, each filter would require 50000 multiplies and additions per sample, or 2.5 billion multiply-adds per second. Handling a simulation of f.i. three sources and two listening points (two ears of one listener), we reach 30 billion operations per second to reproduce the reverberation. This computational load would require at least 10 Pentium CPUs clocked at 3 Ghz, assuming the CPU would be doing nothing else at the same time, and assuming both a multiply and addition can be initiated each clock cycle, with no wait-states caused by the required memory accesses (Smith, 1993).

Thus, it can be concluded that a point-to-point transfer function to reproduce a sound reverberation is prohibitively expensive computationally. Although some applications, mainly in the field of acoustical wave simulation used for scientific or measurement purposes, do use derivative models of a full point-to-point transfer function, such as described in US2015/78563 ‘Acoustic Wave Reproduction Systems’ (Robertson, 2015), it may be clear from the above that, since the obvious methods based on physical modeling are too expensive computationally for most applications, one at first has to take into consideration the perceptually important aspects of reverberation, and how these can be provided by more efficient computational structures.

It is generally considered that the reverberation problem can be simplified without sacrificing perceptual quality. For example, typically the echo density increases as t², where t is time. Therefore, beyond some time, the amount of echoes is so great that it can be modeled as a uniformly sampled stochastic process without loss of perceptual fidelity. In particular, there is no need to explicitly compute each echo per sample of sound. For smoothly decaying late reverb, an appropriate random process sampled at the audio sampling rate will sound equivalent perceptually. The required time density considered perceptually acceptable is 1000 echoes per second (Schroeder, 1961). However, the time density may have to be as high as 10000 for impulsive sounds with high transients (Gardner, 1998).

Similarly, it can be shown that the number of resonant modes in any given frequency band increases as f², so that above some frequency, the modes are so dense that they are perceptually equivalent to a random frequency response generated according to some statistics. In particular, there is no need to explicitly implement resonances more densely packed, rather the required modal density equals a regular spaced density of frequencies across the frequency range, but not too regular, since this produces audible periodicity in the time-domain and disbalances the smoothness of the response.

The set criteria come somewhat close to exponentially decaying a white noise signal as a reverberation impulse response. This satisfies both smoothness criteria in the time domain and frequency domain (Moorer, 1979). However, since natural reverberation decays faster at high frequencies, it is better to say that the ideal reverberation impulse response is exponentially decaying ‘colored’ noise, with the high-frequency energy decaying faster than the low-frequency energy.

The methods known-in-the-art for reproducing reverberation can be divided into two directions. On the one hand, there is the field of artificial reverberation, typically consisting of elements that constitute delay lines, comb filters and all-pass filters, an approach introduced as the Schroeder all-pass section (Schroeder, 1961) and serving as the basis for most commercial devices for artificial reverberation and related effects until today. In many applications of artificial reverberation, such approach has been combined with a feedback-delay network (FDN), first suggested for use in artificial reverberation by Gerzon who reasoned that although individual banks of all-pass filters yield poor quality of reverberation, several such filters may produce good criteria for quality reverberation when cross-coupled (Gerzon, 1972).

Among the state-of-the-art, we find many applications using the typical elements of artificial reverberation, such as described in US2013/216073 ‘Speaker and Room Virtualization using Headphones’ (Lau, 2013) and W02016/130834 ‘Reverberation Generation for Headphone Virtualisation’ (Fielder et al, 2016). Such systems are generally optimised for efficient reverberation processing on a stereo sound system, i.e. stereo loudspeaker configurations or headphone virtualisation through binaural audio rendering techniques—although some applications also address adaptation of the proposed methods for multi-channel distribution, typically by a particular spreading algorithm of a stereo signal across multiple channels, such as described in US2008/273708 ‘Early Reflection Method for Enhanced Externalisation’ (Sandgren et al, 2008).

While such approaches known-in-the-art are successful in efficient processing of sound reverberation that satisfies the perceptual criteria, and as such they are pleasing to the ears as a reverberation and comprise useful tools in the variety of audio and music production practices and user applications, such applications fail to translate actual fundamental aspects of acoustical spaces, such as the shape of a space, expressed e.g. in specific resonance modes resulting from the echoes and varying strongly throughout a space based on standing wave distribution that occurs of a sound reflecting in a shape of particular dimensions; the size of a room, which influences the length of the reflections and the fundamental frequencies of the resonance modes; and, the materiality of a space, expressed in the time to decay different frequency bands dissipating faster or slower based e.g. on the absorption and reflectivity of the materials a space is built from.

In fact, the approaches known-in-the-art for artificial reverberation are inherently incapable of achieving such qualitative aspects that make up the character of a real acoustical space, due to their fundamental technical design. This is, because the criteria for smoothness and density are achieved with carefully chosen sets of fixed delay times and a fixed signal distribution that satisfies the outcome for a limited set of all-pass sections including the delay lines passing through a FDN network. As a result, every reverberation system based on such design has its own ‘abstract’ character, which is not representative of a specific acoustical space or situation, such as a space with a shape, size and built of particular materials; and only a limited set of parameters can be varied to modify the given character, such as the decay time, amount of damping and pre-delay being the typical front-end user variables.

On the other hand, there is the field of convolution-based reverberation, typically using recorded impulse responses (IR) from a real acoustical space to perform a convolution of the recorded signal and an audio input signal, such as described in EP3026666 ‘Reverberant Sound Adding Apparatus, Reverberant Sound Adding Method and Reverberant Sound adding Program’ (Shirakihara et al, 2015). Such approach does yield specific characteristics of acoustical spaces, including characteristics due to shape, size and material construct, and incorporates those aspects successfully into the obtained audio signal resulting from the convolution operation.

Nevertheless, acquisition of recorded data from spaces presents many practical problems, including having to get access to a particular space for the purpose of recording IR and the considerations regarding the technical means and standardisation of the means to acquire the desired IR. Although several libraries with convolution reverberations from real spaces have been collected in recent times, the availability of different rooms and shapes remain very limited in choice.

Another problem is posed by the sheer amount of data needed to acquire a high-enough resolution for this approach, which equals an X amount of directional signals from X amount of locations in a space. Present standards prescribe X32 angles at X24 horizontal positions as a quality standard for acquiring a convolution-based reverberation that is adaptable to a limited resolution of (horizontal) listening points and discrete point sources in the virtualized spatial model. This constitutes 786 pre-recorded audio signals that require convolution with the input signal at a high enough sample rate (≥44.1 kHz p/second), which is still very expensive for available memory and processing of most CPU standards available today and thus limits user applications with high-quality, real-time convolution-based reverberation.

Furthermore, the recorded data constitute a specific and fixed set of data of one space which is not adaptable. Thus, transformation of such a virtual spatial model, by changing or adapting its size, shape or other attributes (in real-time), is not possible. This gives the convolution-based approach a large disadvantage over systems based on artificial reverberation, which features are to a larger extend adaptable by a user, at least with regards to its decay time and aspect of frequency response such as damping; and, the generated audio output is more easily adaptable to provide reproduction for a variety of output systems, i.e. loudspeaker configurations.

Hence, there is a need in the art for a method to generate sound reverberation that can accurately reproduce the characteristics of acoustical spaces, such as its shape, size and materiality, with the efficiency and (real-time) adaptability of elements used in artificial reverberation.

### SUMMARY

Hence, a method for generating a reverberation audio signal associated with a virtual object is disclosed. The method comprises storing a representation of the virtual object, the representation defining a plurality of virtual points constituting the virtual object, wherein the virtual points have respective virtual positions with respect to each other, and wherein the virtual points belong to symmetry groups of virtual points. The symmetry groups of virtual points are obtainable by
for each virtual point out of the plurality of virtual points, defining a set of one or more virtual distances comprising the respective virtual distances between the virtual point in question and the respective other virtual points out of the plurality of virtual points, and
for each set of one or more distances associated with a virtual point, removing distances that are integer multiples of any other distance in the set in question to obtain a further set of one or more distances associated with the virtual point; and
for each further set of one more distances associated with a virtual point, determining the distinct distances in the further set in question to form a virtual point specific set of one or more distances associated with the virtual point; and
determining virtual points that have the same respective virtual point specific sets of one or more distances to form a symmetry group of virtual points, the symmetry group of virtual points thus being associated with a set of one or more symmetry group distances that is the same as the virtual point specific sets of its virtual points.

The sets of one or more symmetry group distances which sets are respectively associated with symmetry groups, together form a further set of one or more distances. The method further comprises receiving and/or storing and/or generating an input audio signal, and, for each virtual point, determining, based on the input audio signal, or filtered version thereof, a virtual point audio signal component. The method also comprises combining the virtual point audio signal components to obtain a composite audio signal, and determining for each distinct distance in the further set of one or more distances, based on the composite audio signal one or more distance audio signals. The method also comprises determining the reverberation audio signal based on the one or more distance audio signals and the virtual point audio signal components.

This method allows to incorporate the spatial information of the virtual object, such as a room, into the generated reverberation audio signal. As a result of the method, the generated reverberation audio signal possesses the same characteristics as an audio signal that has been recorded in a particular room with its particular acoustics, while actually, an virtual object as represented by the virtual points is causing the reverberation. To illustrate, the virtual object may be a virtual room having virtual walls, floor and ceiling, wherein the virtual walls, floor and ceiling consist of a certain material. In such case, a subject hearing the reverberation audio signal may perceive the audio signal as if he or she is actually standing in the virtual room.

The center point may be understood to be a point through which a rotational axis can be defined in such manner that the virtual object can rotate, starting from an initial orientation and position, less than 360 degrees around the rotational axis and arrive at an orientation and position that are identical to the initial orientation and position. Such rotation of a virtual object may also be referred to as an object preserving rotation. If the virtual object for example is a square plane, then the rotational axis is perpendicular to the plane and the center point would be the midpoint of the rectangle, because a rotation of 90 degrees, which is less than 360 degrees, around such rotational axis through the midpoint would cause the square virtual object to be in a position and have an orientation that is identical to the initial position and orientation.

Any first and second virtual point of a virtual object that are positioned symmetrically about the center point of the virtual object may be understood such that the first virtual point is at the position of the second virtual point if an object preserving rotation is performed.

Additionally or alternatively, any first and second virtual point of a virtual object that are positioned at equal distances from the center point may be understood to be symmetrically positioned about the center point.

As used herein, combining two or more signals may comprise summing these signals.

In an embodiment, the method comprises determining for each symmetry group, based on the determined distance audio signals, one or more symmetry group audio signals. This embodiment also comprises determining the reverberation audio signal based on the symmetry group audio signals and the virtual point audio signal components.

Since each symmetry group audio signal is determined based on the distance audio signals, in this embodiment, the reverberation audio signal is determined based on the one or more distance audio signals as well.

In an embodiment, determining a virtual point audio signal component for each virtual point based on the input audio signal, or filtered version thereof, comprises, for each virtual point, performing a virtual-point-specific operation on the input audio signal, or modified, e.g. filtered, inverted and/or attenuated or amplified, version thereof. Herein, performing the virtual point specific operation comprises performing a time delay operation introducing a time delay, wherein the introduced time delay is approximately equal to a virtual distance between the virtual point in question and a virtual sound source divided by a speed of sound.

Preferably, the virtual representation also defines the virtual positions of the virtual points with respect to a virtual sound source and/or with respect to an observer. The virtual distance between a virtual point of the virtual object and the virtual sound source may be defined as the virtual distance between the virtual point and a center of the virtual sound source. The generated reverberation audio signal may be understood to reflect an audio signal that originates from this virtual sound source.

This embodiment is advantageous in that the shape of the virtual object can be taken into account when generating the reverberation audio signal.

The speed of sound may be the speed of sound in a virtual medium that is defined between a virtual object, a virtual sound source and an observer. For example, a virtual medium between virtual object and virtual sound source may be defined to be air at a temperature of 20 C and an average 50% humidity. In such case, the speed of sound should be approximately 343 m/sec, which is the speed of sound in air at a temperature of 20 C and an average 50% humidity. The representation of the virtual object may define the virtual medium between the virtual object and the virtual sound source.

In an embodiment, determining for each distinct distance in the further set of one or more distances, one or more distance audio signals comprises determining for each distinct distance in the further set of one or more distances, a first distance audio signal and a second distance audio signal. Herein, determining the first distance audio signal for a distinct distance comprises modifying the composite audio signal by performing a time delay operation introducing a time delay and a signal feedback operation. Further, determining the second distance audio signal for the distinct distance comprises modifying the composite audio signal by performing a second time delay operation introducing a second time delay and a second signal feedback operation and a signal inverting operation.

It should be appreciated that, preferably, the first distance audio signal and the second distance audio signal only differ in that one is an inverted version of the other. This embodiment is advantageous in that it increases the number of harmonics per distinct distance, which increases the modal density in the reverberation audio signal, and that the harmonics per distinct distance are optimally spread, i.e. odd and even harmonics are distributed to symmetrically opposite virtual points constituting the virtual object, as explained with reference to FIG. 11.

In an embodiment, the first time delay introduced by the first time delay operation is equal to the distinct distance divided by a speed of sound.

It should be appreciated that the second time delay and the first time delay are in principle the same.

As indicated above, the speed of sound is preferably the speed sound associated with the virtual medium between the virtual object and virtual sound source as for example defined by the representation of the virtual object.

In an embodiment, determining for each symmetry group, based on the distance audio signals, one or more symmetry group audio signals comprises determining, for each symmetry group, a first symmetry group audio signal and a second symmetry group audio signal. Determining the first and second symmetry group audio signals comprises, selecting a distance audio signal out of every pair of first and second distance audio signal, each pair having been determined for a respective distance out of the set of one or more symmetry group distances associated with the symmetry group in question, and combining the selected distance audio signals in order to determine the first symmetry group audio signal and combining the non-selected distance audio signals out of every said pair of first and second distance audio signal in order to determine the second symmetry group audio signal.

The selection of the signals to be used for determining the first symmetry group audio signal, and thus the selection of the signals to be used for determining the second symmetry group audio signal, may be performed in an arbitrary manner. This embodiment ensures that out of each pair of first and second distance audio signal one contributes to the first symmetry group audio signal and the other contributes to the second symmetry group audio signal.

In an embodiment, determining the audio signal based on the symmetry group audio signals and the virtual point audio signal components comprises combining the symmetry group audio signals with the virtual point audio signal components to determine said reverberation audio signal.

A reverberation audio signal preferably mimics the first reflections from the virtual object as well as the reverberation tail that the virtual object produces. The virtual point audio signal components cause the reverberation audio signal to mimic the first reflections from the virtual object whereas the symmetry group audio signals cause the reverberation audio signal to comprise a reverberation tail associated with the virtual object.

In an embodiment, determining the audio signal based on the symmetry group audio signals and the virtual point audio signal components comprises combining the symmetry group audio signals with the virtual point audio signal components to determine said reverberation audio signal. Herein, combining the symmetry group audio signals with the virtual point audio signal components to determine said audio signal comprises determining modified audio signal components. Further, determining modified audio signal components comprises adding, to each virtual point audio signal component determined for a virtual point belonging to a symmetry group, the first or second symmetry group audio signal of the symmetry group in question.

This embodiment provides an efficient manner for combining the symmetry group audio signals with the virtual point audio signal components.

In principle, every virtual point, and thus every audio signal component, belongs to a single symmetry group for which two symmetry group audio signals are determined. Determining which symmetry group audio signal, the first or second, is added to an audio signal component may be performed in accordance with the principle that the first and second symmetry group audio signals are added to respective audio signal components in an alternating manner, such that, half—or in case of uneven number of virtual points in the symmetry group, roughly half—of the audio signal components associated with a symmetry group combines with the first symmetry group audio signal for that symmetry group and the other half of the audio signal components combines with the second symmetry group audio signal for that symmetry group.

Determining the modified audio signal components may further comprise other operations for adding resonance, depth, height and distance characteristics to the audio signal components.

In an embodiment, the method comprises performing the method according to any of the preceding claims for generating a further reverberation audio signal for a further virtual object, wherein the determined reverberation audio signal associated with the virtual object is used as input audio signal.

This embodiment enables to simulate one reverberating virtual object producing a reverberation audio signal that is incident on another virtual object. This allows to generate reverberation audio signals for complex virtual systems comprising multiple virtual objects, such as several, differently oriented surfaces, such as walls, ceilings, floors, et cetera.

In an embodiment, the method further comprises combining the reverberation audio signal associated with the virtual object and the further reverberation audio signal associated with the further virtual object, and, optionally, providing the combination to one or more loudspeakers.

In an embodiment, the method further comprises providing the determined audio signal to one or more loudspeakers

In an embodiment, the method comprises providing the modified audio signal components to one or more loudspeakers comprises providing the modified audio signal components to a panning system that is configured to distribute the modified audio signal components to a plurality of loudspeakers.

Distributing the modified audio signal components may comprise determining a number of output audio signals, one for each loudspeaker, based on the modified audio signal components.

In an embodiment, the method further comprises filtering the input audio signal before determining, for each virtual point, a virtual point audio signal component. Filtering the input audio signal comprises applying a multi-band filter comprising attenuating respective frequency bands in the input audio signal using respective attenuation coefficients, wherein the respective attenuation coefficients are determined based on a material of the virtual object.

Preferably, the representation defining the virtual object also defines out of which material the virtual object consists. To illustrate, the representation may define that the virtual object consists of limestone. The material of the virtual object may have known specific absorption coefficients for respective frequency bands. The attenuation coefficients that are used for the multiband filters may be determined on the basis of these absorption coefficients.

In an embodiment, determining for each distinct distance in the further set of one or more distances, one or more distance audio signals comprises determining for each distinct distance in the further set of one or more distances, a distance audio signal. Determining such distance audio signal comprises modifying the composite audio signal by performing a time delay operation introducing a time delay, a signal attenuation operation, a low-pass filter operation and a signal feedback operation. This embodiment also comprises determining for at least one, preferably for each, symmetry group of virtual points a density index. Determining the density index for the at least one symmetry group comprises
determining for each distance out of the set of one or more symmetry group distances associated with the at least one symmetry group, how many feedback operations for determining a distance audio signal for the distance in question are performed per unit of time, for example by dividing said unit of time by the time delay introduced by the time delay operation performed for determining the distance audio signal in question, thus obtaining for each distance out of the set of one or more symmetry group distances associated with the at least one symmetry group respective numbers of performed feedback operations, and
adding the respective numbers of performed feedback operations to obtain the density index for the symmetry group of virtual points.

This embodiment also comprises receiving a threshold value for the density index, and determining that the determined density index is lower than said threshold value, and, based on this determination, changing the stored representation by increasing the number of virtual points that constitute the virtual object.

In principle, increasing the number of virtual points, which may also be referred to as increasing the resolution of virtual points, causes the amount of distinct distances comprising the further set of one or more distances to become larger; and, causes the time delays used for determining the respective distance audio signals to become smaller. As a result, more feedback operations are performed per unit of time. Each feedback operation may be understood to represent an echo. Thus, this embodiment may be said to ensure that sufficient echoes are generated.

In an embodiment, the low pass filter operation comprises
determining that the to be low-pass filtered signal is associated with a Nyquist frequency that is lower than a cut-off frequency associated with the low pass filter operation, and
based on this determination, up-sampling the to be filtered signal so that it is associated with a Nyquist frequency that is higher than or equal to said cut-off frequency, and
low-pass filtering said up-sampled signal, and,
optionally, determining that the filtered signal is associated with a higher sample rate than an output sample rate, wherein the output sample rate is the sample rate that can be output by an output system, and, based on this determination, down-sampling the filtered signal.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run on a computer system, being configured for executing any of the methods described herein.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 illustrates an observer that is subject to a reverberation audio signal according to embodiment;

FIG. 2 is flow chart illustrating a method for generating a reverberation audio signal according to an embodiment;

FIG. 3 is a flow chart illustrating the inputs for the respective modules described in FIG. 2 according to an embodiment;

FIG. 4 illustrates a method for generating a reverberation audio signal according to an embodiment;

FIG. 5 illustrates an embodiment for generating a reverberation audio signal;

FIGS. 6A-C show a detailed flow chart illustrating a reverberation audio signal generating method according to an embodiment;

FIG. 7 shows the generation of a reverberation audio signal for a mono sound system according to an embodiment;

FIG. 8 shows the generation of a reverberation audio signal for a stereo sound system according to an embodiment;

FIG. 9 illustrate symmetry group distances for six symmetry groups;

FIG. 10 shows a further set of one or more distances according to an embodiment;

FIG. 11 shows symmetry groups of several different virtual objects;

FIG. 12 is a flow process for a ‘value filter’ operation to determine time delays according to an embodiment;

FIG. 13 Illustrates a flow process for a ‘sample rate interpolation’ operation according to an embodiment;

FIG. 14 schematically shows a user interface according to an embodiment;

FIG. 15 is a block diagram illustrating a data processing system according to an embodiment.

FIGS. 16A-D illustrate modules encoding resonance, depth, height and distance into an audio signal component according to respective embodiments;

FIG. 17 is a panning matrix according to an embodiment;

FIGS. 18A-18G illustrate modules for adding resonance characteristics to an audio signal component according to respective embodiments;

FIG. 19 illustrate modules for adding depth characteristics to an audio signal component according to respective embodiments;

FIG. 20 illustrate modules for adding distance characteristics to an audio signal component according to respective embodiments;

FIG. 21 illustrates a shape generator for determining the dimensions, position and orientation of the virtual object and its virtual points according to an embodiment.

### DETAILED DESCRIPTION OF THE DRAWINGS

In the figures, identical reference numbers indicate similar or identical elements. Further, elements that are depicted with dashed lines are optional elements.

This disclosure relates to methods and systems for generating a reverberation audio signal. An actual reverberation audio signal may be understood to be formed by sound reflections by an object and also subsequent vibrations in such object. The generated reverberation audio signal as described herein is associated with a virtual object in the sense that the reverberation audio signal comprises the same characteristics as an actually recorded audio signal that is subject to the reverberation of such object. In principle, the virtual object may have any shape, size and/or characteristics.

The methods described herein enable to generate reverberation audio signals at the highest computational efficiency allowing real-time processing. The ability to generate the reverberation audio signal in real-time for example allows to change characteristics of the virtual object, such as its shape, position, orientation and/or the material out of which the virtual object is formed, and to immediately generate the reverberation audio signal associated with the changed virtual object. In particular, the conditions of a virtual acoustical space, such as its material construct, conditions for sound propagation, the spatial distance, height and depth of sound sources reflecting in the space and/or from objects comprising other sound sources can be changed and these changes can be quickly processed.

The method and system for generating the reverberation audio signal uses relatively simple elements of artificial reverberation, such as delay lines and low-pass filters. The technologies disclosed herein are designed to minimize the number of delay lines required in the system, for example in that smart signal distribution across multiple audio components is realized, which is computationally much less expensive.

The technologies disclosed herein enable to add features to an input audio signal such to make it seem as if the input audio signal has been generated and/or recorded in an actual acoustical space of a given shape, size and materiality.

The method is optimally efficient and scalable in resolution for lower to high-capacity CPU requirements. The method allows for an interactive model for generating reverberation as the processes may be executed in real-time while performing at optimal resolution given by the conditions of the CPU used. The method allows adaptability to any variety of loudspeaker configurations and amounts of loudspeakers used in a configuration, stimulating new approaches to loudspeaker system design while also being backwards compatible with existing audio reproduction formats, such as mono, stereo and/or HTRF-based headphone sound reproduction.

The method to obtain the delay times is not based on fixed sets of time delay values with a statistically valid outcome, but may be generated in real-time from a ‘shape generator’ operation which allows to model a shape of any type and/or character by determining a virtual point resolution, i.e. a set of points defined on the virtual shape. The resulting time delays are filtered using a ‘value filter’ operation that extrapolates essential data from the shape, such that it will accurately represent the acoustical shape in the first and early reflections of the reverberation, while at the same time producing a reverberation tail , i.e. the late reverberations, that satisfies the perceptual criteria of smoothness, time density and modal density using the same set of time delays and without the need to incorporate a feedback-delay network (FDN). Furthermore, the invention introduces new approaches to automate optimisation of density and sample rate requirements for different user conditions set by a user.

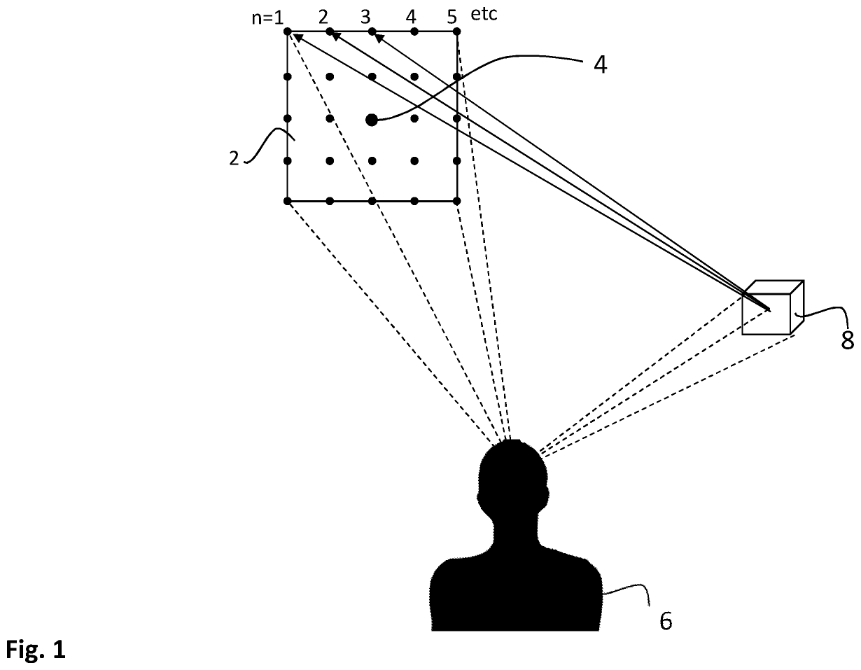

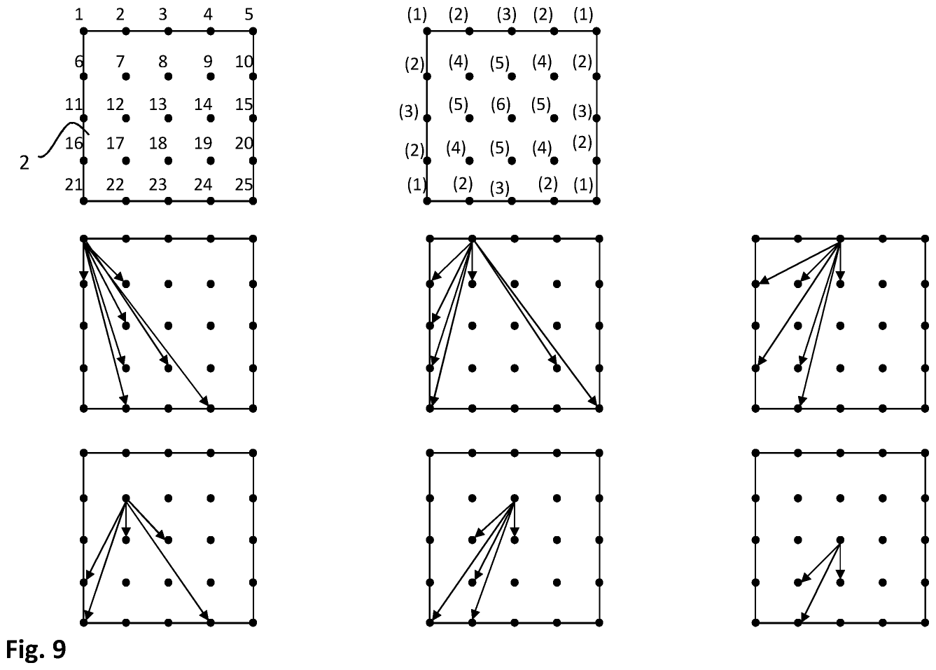

As explained above, the method for generating a reverberation audio signal involves a representation of a virtual object 2, such as a square plate depicted in FIG. 1. The representation defines a plurality of virtual points, numbered {1, 2, 3, . . . , N} in FIG. 1. In this disclosure “N” indicates the total number of virtual points. The virtual points have respective virtual positions with respect to each other and with respect to a center point 4 of the virtual object 2. The virtual points belong to symmetry groups of virtual points, wherein virtual points that are positioned symmetrically about the center point, belong to the same symmetry group of virtual points. This will be explained in more detail with reference to FIG. 9.

The virtual points defined by the representation also have a specific position with respect to an observer 6. As such, the virtual object may for example be positioned at a certain distance from the observer, at a depth below the observer or at a height above the observer. Further, the virtual points may also have a position with respect to a sound source 8.

The observer 6 may perceive that the virtual object 2 has a shape, i.e. a distinct dimensional shape, size and materiality, and may perceive the sound source 8 and reverberating space at a distinct height, depth and distance in relation to the observer. Such perception closely resembles how one experiences sound in a real space of such shape, size and material construction, and how one can move through this space and explore how it sounds from any position and angle. Thus, a listener may virtually and/or physically move through space and experience the resulting sound reverberation, i.e. the acoustics of a space of a particular size, shape and materiality, from any position and angle inside and/or outside the reverb space, and experience the result of the excitation of the reverberation of a virtual object located at any virtual position.

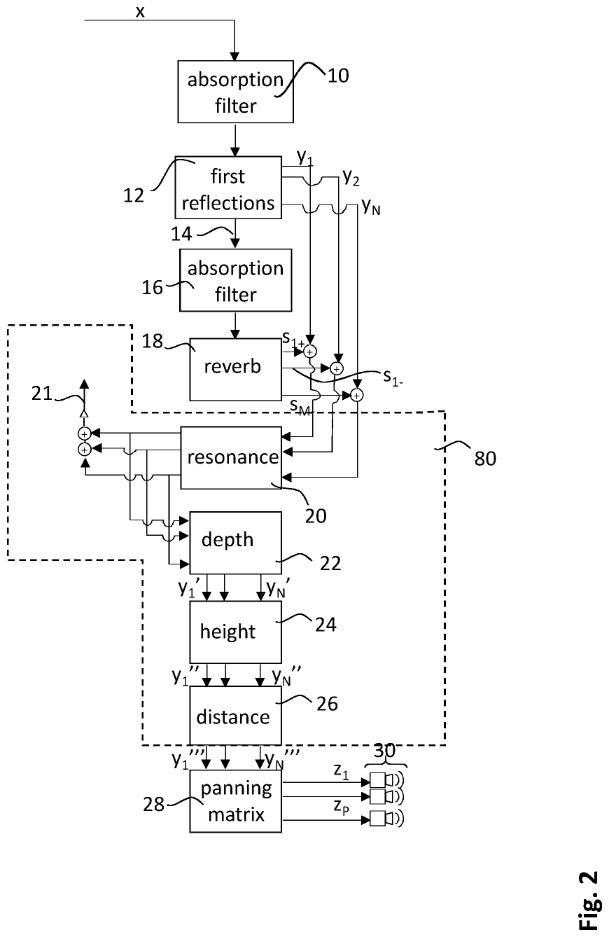

FIG. 2 is a flow chart illustrating a method for generating a reverberation audio signal according to an embodiment. Herein, an input audio signal x is provided to a multi-band filter that is configured to attenuate respective frequency bands in the input audio signal using respective attenuation coefficients. An attenuation coefficient may be understood to define a degree of attenuation for a specific frequency band. For example, the multi-band filter may be configured to attenuate a first frequency band using an attenuation coefficient of 0.7 and a second frequency band using an attenuation coefficient of 0.5. As a result, the intensities of frequencies in the first frequency band are damped with a factor 0.7 and the intensities of frequencies in the second frequency band are damped with a factor 0.5. Such filter 10 may also be referred to as an absorption filter because it may be used to model the absorption of sound by the virtual object. In an example, the absorption filter is an 8-octave band equalizer.

In the embodiment shown in FIG. 2 the output of filter 10 is subsequently provided to a first reflections module 12. Such module preferably comprises a plurality of parallel signal flows, one for each virtual point of the virtual object 2 in order to determine a virtual point audio signal component y_n for each virtual point as shown. A module may also be referred to as a flow process, flow chart or the like.

In the embodiment of FIG. 2, the virtual point audio signal components y_n are combined, e.g. summed, in order to obtain a composite audio signal, ΣLₙ₌₁^{N} y_n, indicated by 14.

Further, the composite audio signal 14 is provided to a second filter 16, which may be identical to filter 10.

Then, the output of the second filter 16 is provided to a module 18 for generating a reverberation tail. The module 18 comprises a plurality of parallel signal flows, one for each to be generated distance audio signal as described herein. The module 18 determines one or more distance audio signals d_k+/−, i.e. {d_1+, d_1−, d_2+, d_2−, d_K+, d_K−} (not shown). “K” as used in this disclosure indicates the total number of distinct distances in the further set of one or more distances as described herein.

The module 18 outputs a number of symmetry group audio signals s_m+/−, i.e. {s_1+, s_1−, s_2+, s_2−}, s_M+, “M” as used in this disclosure indicates the total number of symmetry groups.

In the embodiment of FIG. 2, the symmetry group audio signals s_m+/− are combined with the virtual point audio signal components y_n. This combination results in a reverberation audio signal according to an embodiment.

FIG. 2 further shows optional modules, namely resonance module 20, depth module 22, height module 24, distance module 26, panning system 28. These modules are not required for generating a reverberation audio signal, but are required for coherent projection of the reverberation audio signal with respect to an observer, i.e. the reverberation is perceived at distinct depth, height and distance and angle by the observer. The resonance module 20 is configured to perform a spatial wave transform on audio signal components for adding resonance characteristics to the audio signal components, the sum of which may be a mix-down 21 of an audio input signal for a (second) signal process as described herein. The depth module 22 is configured to encode depth to audio signal components. The height module 24 module is configured to encode height to audio signal components. The distance module 26 is configured to encode distance to audio signal components.

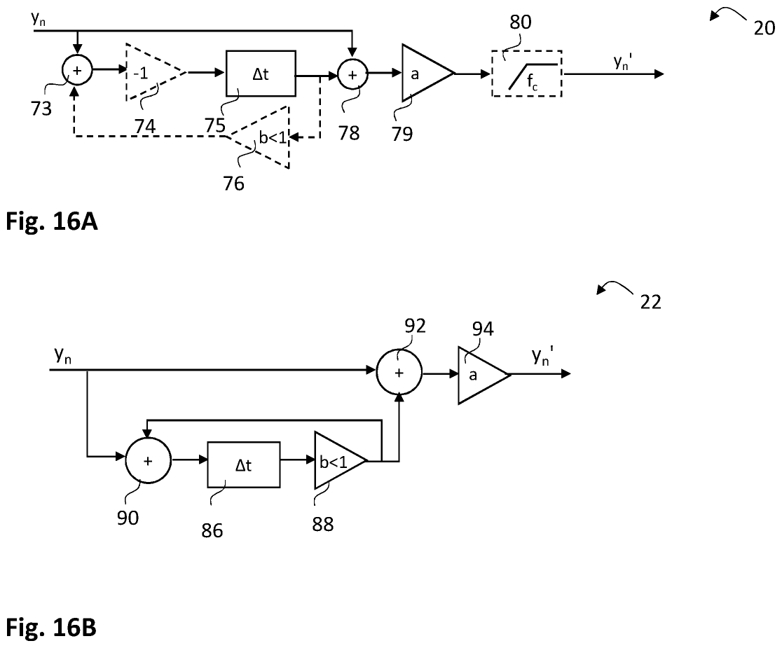

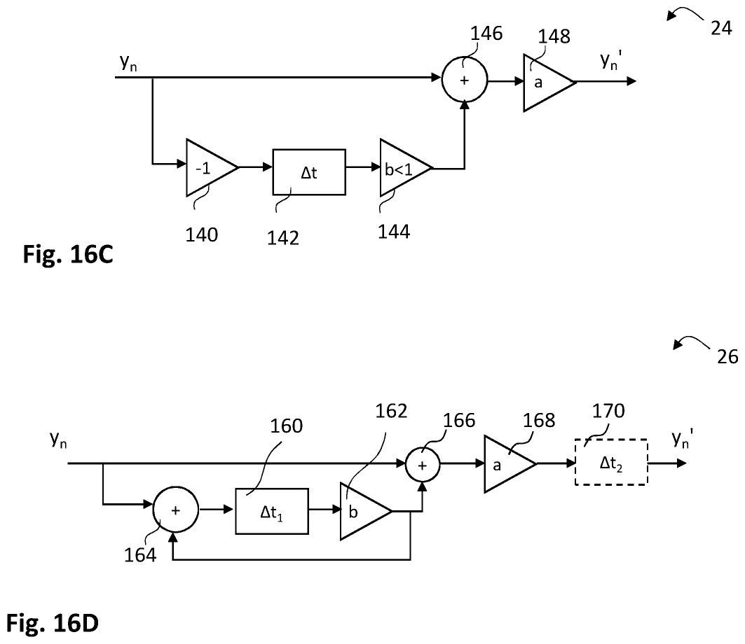

Adding resonance characteristics, which may be performed by resonance module 20, may comprise (see FIG. 16A) modifying the audio signal component in order to obtain a first modified audio signal component. This modification of the audio signal component optionally comprises a signal inverting operation 74, comprises a signal delay operation 75 introducing a time delay, and optionally comprises a signal feedback operation 73 as shown. In the depicted embodiment, the signal that is fed back is attenuated as shown by the amplifier 76 having a gain smaller than 1. Then, the first modified audio signal component is combined, see the summation 78, with the audio signal component in order to obtain a second modified audio signal component. Furthermore the second modified audio signal is further modified by an attenuation operation 79 and, optionally, a high-pass filter operation 80 to obtain an audio signal component y_n′ associated with a virtual point of the virtual object. The formula for determining the time delay that is introduced for determining the modified audio signal component may be given by

Δt=Vxₙ/v

wherein V is the dimensional volume of the shape and xₙ denotes for point n on the virtual shape a coefficient, each point having a relative spatial position denoted in Cartesian coordinates (x, y, z); and v is a constant relating to the speed of sound through a medium. The determination of the audio signal components is also described in patent applications NL2024434 and NL2025950 which contents should be considered included in this disclosure in their entirety.

The attenuation operation 79 after the summation operation 78 may comprise decreasing the gain G of the audio signal with −6 dB.

In this disclosure, values in the triangles, i.e. in the attenuation or amplification operations, may be understood to indicate a constant with which a signal is multiplied. These constants are often indicated by “a” or “b”. Thus, if such value is larger than 1, then a signal amplification is performed. If such value is smaller than 1, then a signal attenuation is performed.

The cut-off frequency f_{c} for the high pass filter in dependence of point n on a virtual shape may be determined as

f_{c}=v/V2(1−rₙ/R) for rₙ/R≤0.5

f_{c}=v/V2(rₙ/R) for rₙ/R>0.5

where v is a constant relating to the speed of sound through a medium, V is the dimensional volume of a virtual shape, rₙ denotes the spherical radius from the center of a virtual shape to point n, and R denotes the spherical radius from the center of the shape passing through the vertices where two or more edges of a virtual shape meet. In case of two or more values for R, the largest value R is considered.

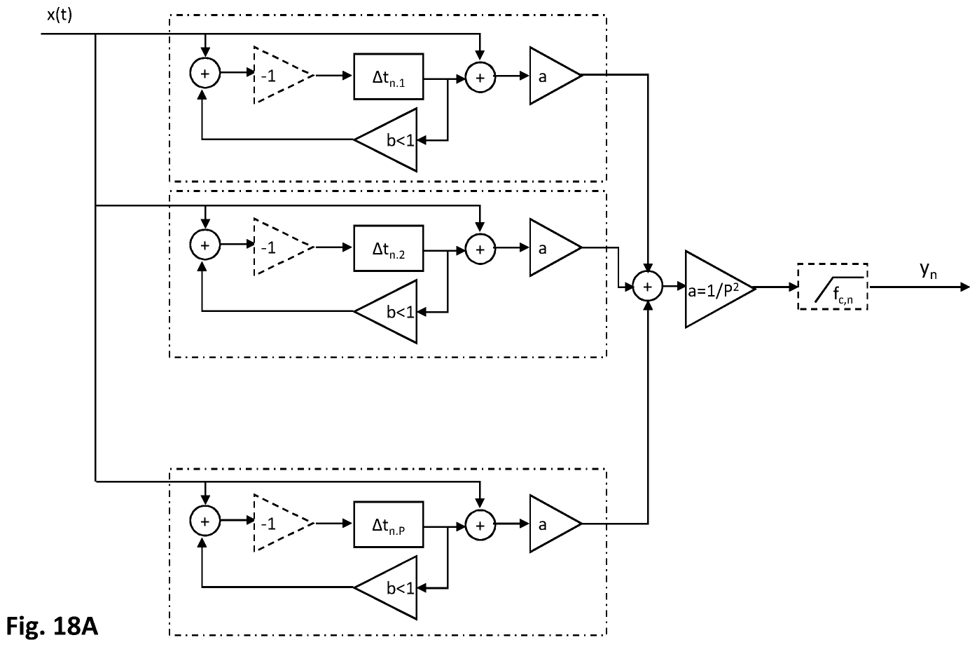

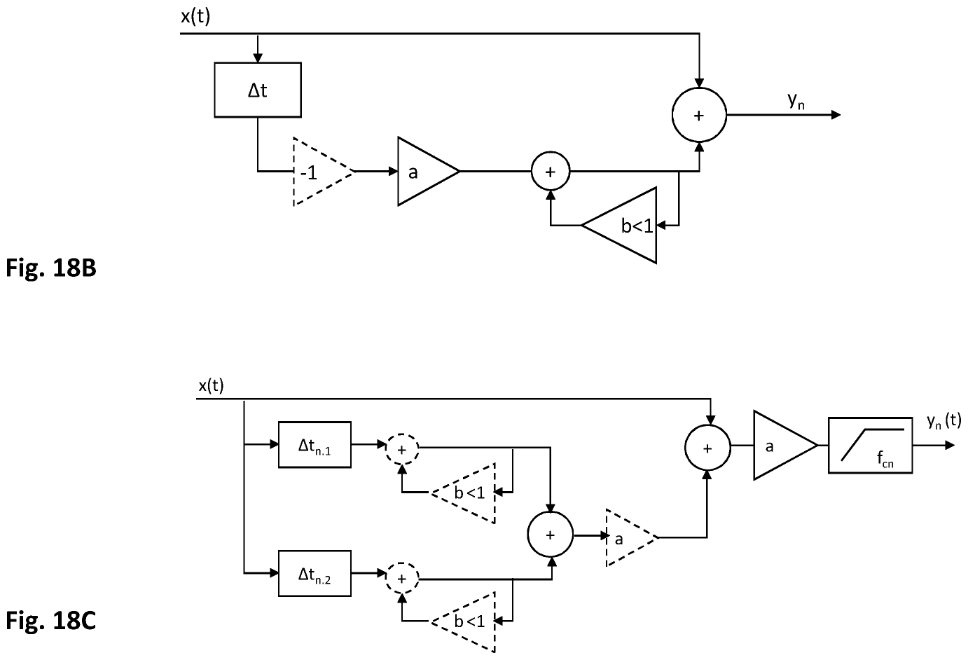

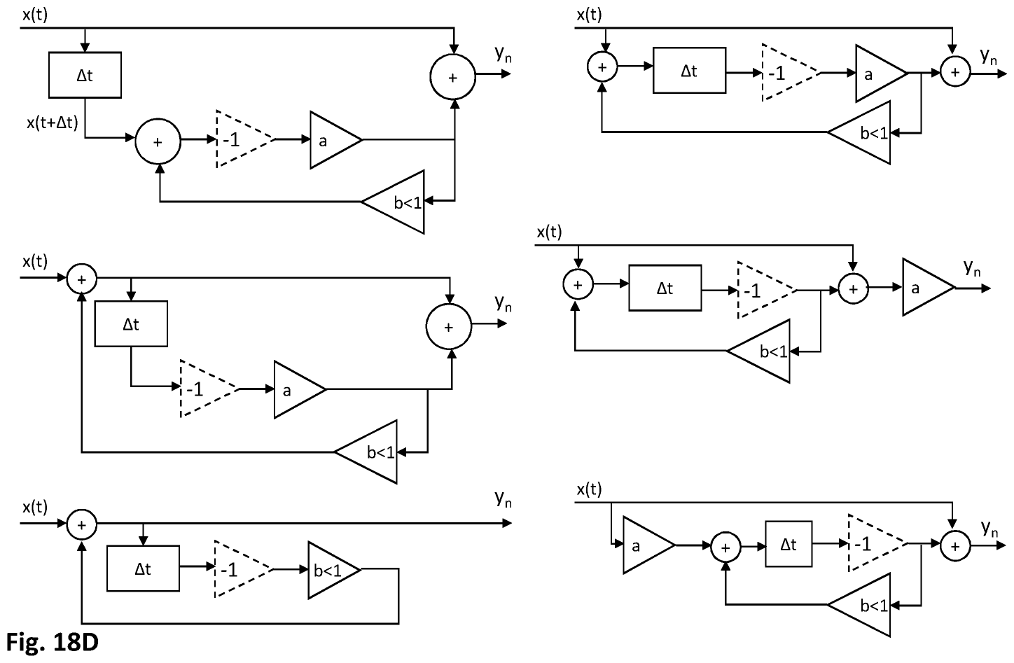

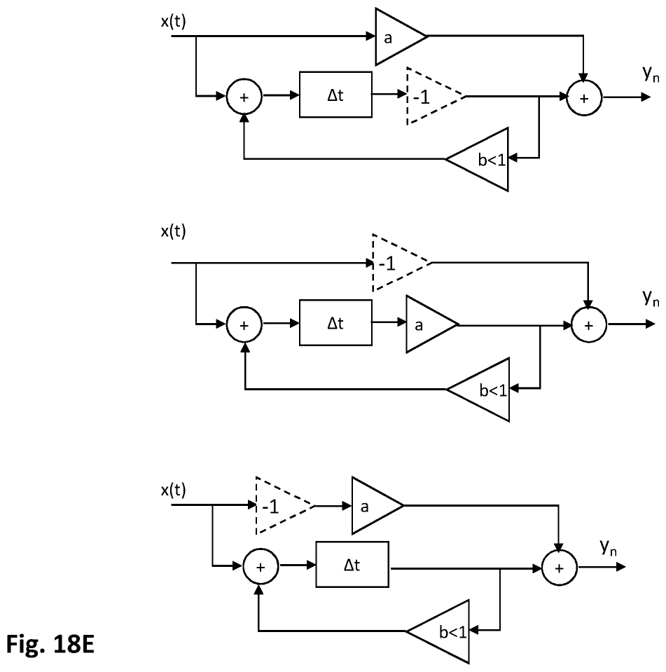

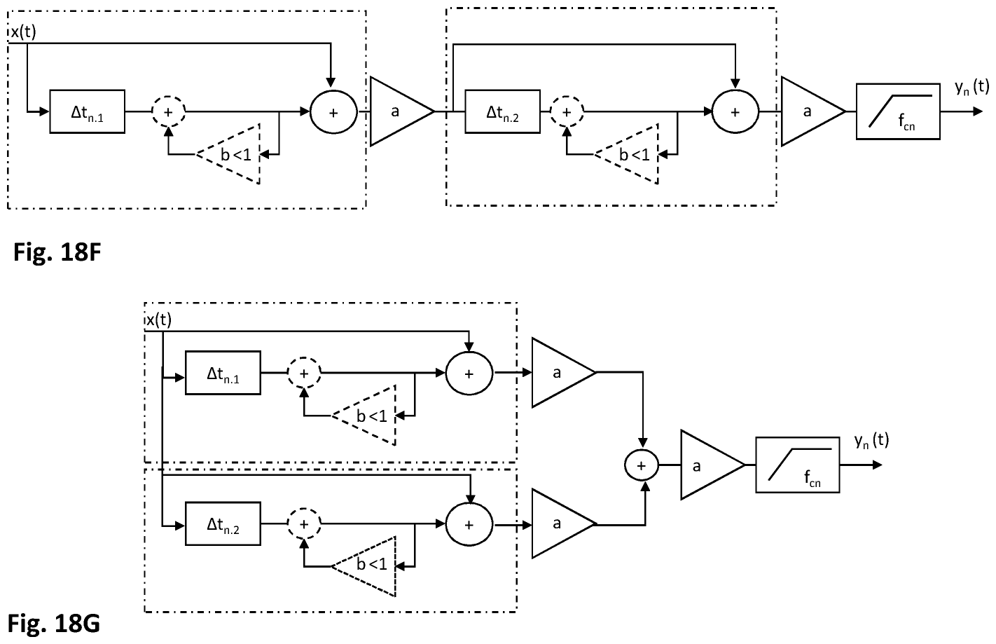

It should be appreciated that instead of the flow chart depicted in FIG. 16A, any of the flow charts depicted in any of the FIGS. 18A-18G may be used instead for adding resonance characteristics with the same parameter values.

Adding depth characteristics to an audio signal component, as may be performed by module 22, may comprise (see FIG. 16B) modifying the audio signal component y_n in question using a time delay operation 86 introducing a time delay, a signal attenuation 88 and a signal feedback operation 90 in order to obtain a modified version of the audio signal component and combining 92 the modified version of the audio signal component with the audio signal component in question. The signal attenuation 88 is performed in dependence of the virtual depth below the subject of the virtual point associated with the audio signal component in question.

In this embodiment, the signal attenuation is defined by parameter “b”. If value b=0 no depth of the virtual point below the subject will be encoded, if value b=1, a maximum depth for the virtual point associated with the audio signal component will be encoded.

The value “a” with which the result of the combination of modified audio signal and input audio signal is optionally attenuated or amplified 94 equals to

a=(1−b)x

where x is a multiplication factor to correct the signal gain G depending on the amount of signal feedback b that influences the steepness of a high-frequency dissipation curve. By varying value b, preferably between 0-1, a change in depth is added to the audio signal.

Preferably, the time delay Δt that is introduced by the time delay operation is as short as possible, e.g. shorter than 0.00007 seconds, preferably shorter than 0.00005 seconds, more preferably shorter than 0.00002 seconds. Most preferably, approximately 0.00001 seconds. In case of a digital sample rate of 96 kHz, the time delay may be 0.00001 seconds.

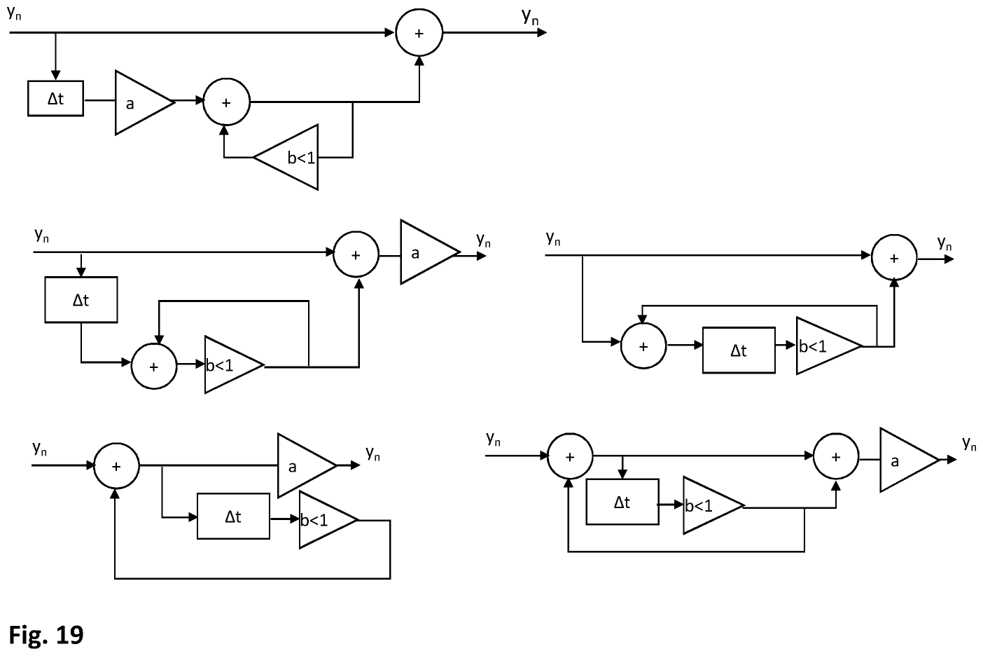

It should be appreciated that instead of the flow chart depicted in FIG. 16B, any of the flow charts depicted in FIG. 19 may be used instead with the same values for parameters.

Adding height characteristics to an audio signal component, as may be performed by height module 24, comprises (see FIG. 16C) modifying the audio signal component in question using a signal inverting operation 140, a signal delay operation 142 introducing a time delay and a signal attenuation 144 to obtain a modified version of the audio signal component and combining 146 the modified version of the audio signal component with the audio signal component in question. Herein the signal attenuation 144 is performed in dependence of the virtual height of the virtual sound source.

In this embodiment, if value b=0 no height characteristics will be added to the audio signal component. If value b=1, a maximum height of the virtual point will be perceived. If the first attenuation operation is performed, the gain G of value “a” of optional attenuation 148 may be equal to

a=(1−b)x

where x is a multiplication factor to correct the signal gain G depending on the amount of attenuation b that influences the steepness of a low-frequency dissipation curve. By varying value b, preferably between 0-1, a change in height can be added to an audio signal component.

Preferably, the time delay Δt that is introduced by the time delay operation 142 is as short as possible, e.g. shorter than 0.00007 seconds, preferably shorter than 0.00005 seconds, more preferably shorter than 0.00002 seconds. Most preferably, approximately 0.00001 seconds. In case of a digital sample rate of 96 kHz, the time delay may be 0.00001 seconds.

Adding distance characteristics to an audio signal component, as may be performed by module 26, comprises (see FIG. 16D) modifying the audio signal component in question using a first signal delay operation 160 introducing a first time delay, a first signal attenuation operation 162 and a signal feedback operation 164 in order to obtain a first modified version of the audio signal component and combining 166 the first modified version of the audio signal component with the audio signal component in question to obtain a second modified version of the audio signal component and performing a second signal attenuation 168 and optionally a second signal delay operation 170 introducing a second time delay on the second modified version of the audio signal component. Herein, the first 162 and second 168 signal attenuation are performed in dependence of the virtual distance from the subject.

In dependence of the distance of the virtual point associated with the audio signal component in question the values for b, the attenuation constant for operation 162, and the value for a, the attenuation constant for operation 168, is varied. The constants may be understood to indicate a constant with which a signal is multiplied. Thus, if such value is larger than 1, then a signal amplification is performed. If such value is smaller than 1, then a signal attenuation is performed. When b=0 and a=1 no distance will be encoded and when b=1 and a=0 a maximum distance will be encoded. The gain G of value a may relate to the value for b as

a=(1−b)x

where the value for x is a multiplication factor applied to the amount of signal feedback that influences the steepness of a high-frequency dissipation curve.

Preferably, the time delay Δt₁ that is introduced by the time delay operation 160 is as short as possible, e.g. shorter than 0.00007 seconds, preferably shorter than 0.00005 seconds, more preferably shorter than 0.00002 seconds. Most preferably, approximately 0.00001 seconds. In case of a digital sample rate of 96 kHz, the time delay may be 0.00001 seconds

The optional time delay Δt₂ that is introduced by the time delay operation 170 creates a Doppler effect associated with movement of the virtual sound source. The time delay may be determined as

Δt₂=r/v

wherein r is the distance between the position of virtual point associated with the audio signal component in question denoted in Carthesian coordinates (x, y, z) and the subject, which may be expressed as a vantage point (x, y, z) and v a constant expressing the speed of sound through a medium.

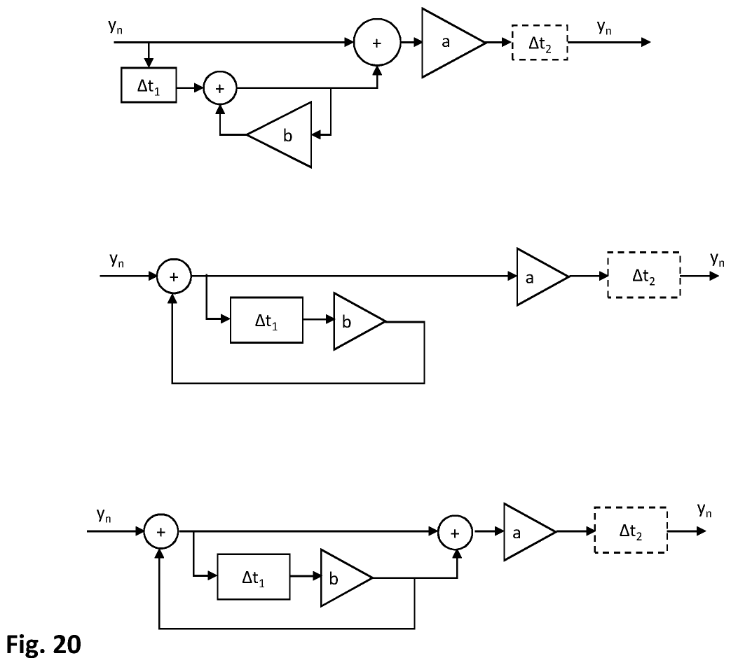

It should be appreciated that instead of the flow chart depicted in FIG. 16D, any of the flow charts depicted in FIG. 20 may be used with the same parameter values.

The panning module 28 is configured to attenuate and sum the modified audio signal components y′_n to generate audio output signals z_p, i.e. {z_1, z_2, z_3, . . . , z_P}, each audio output signal associated with a discrete loudspeaker p. “P” as used herein indicates the total number of loudspeakers.

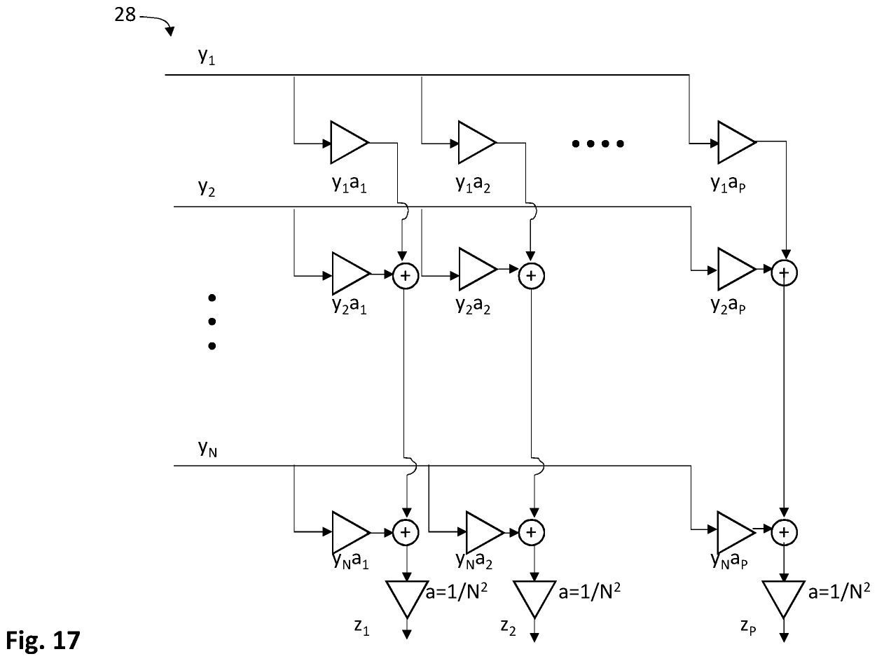

The panning module is further described with reference to FIG. 17. FIG. 17 is a flow chart illustrating a method for determining a loudspeaker audio signal z_p for each loudspeaker p of a plurality P of loudspeakers. The depicted method and system may also be referred to as a signal distribution matrix 28 or panning matrix 28. In this embodiment, a loudspeaker audio signal z_p is determined for each loudspeaker p (not shown) of a plurality of loudspeakers. Input to the signal distribution matrix is the plurality of audio signal components associated with respective virtual points of the virtual sound source which plurality of audio signal components y_n have been determined in accordance with methods described herein.

Each loudspeaker p is associated with a loudspeaker coefficient a_p. In the depicted embodiment, determining loudspeaker audio signal z_p for loudspeaker p comprises attenuating each audio signal component y_n based on loudspeaker coefficient a_p in order to obtain a loudspeaker specific set of attenuated audio signal components. A loudspeaker coefficient for a loudspeaker may be determined based on a distance between the loudspeaker in question and the virtual point. Attenuating each audio signal component y_n based on loudspeaker coefficient a_p may involve simply a multiplication y_n*a_zp. In such case, the loudspeaker specific set of attenuated audio signal components for loudspeaker p may be described by: {y_1*a_p; y_2*a_p; y_3*a_p; . . . ; y_N*a_p}, wherein N denotes the total number of virtual points defined for the virtual sound source. Subsequently, the audio signal components in this set are combined, e.g. summed, in order to arrive at the loudspeaker audio signal z_p for loudspeaker p. This method is performed for all loudspeakers P.

The signal distribution matrix 28 may have a multiplier and a summation at each position where an input line to which an output signal of a multiplier is supplied, crosses an output, as shown in FIG. 17. The multiplier attenuates the signal received from the input line by a prescribed loudspeaker coefficient specified by a controller, such as the values generated for each loudspeaker amplitude by f.i. a panning system commonly known-in-the-art, and outputs a resulting signal to the summation. The processing that the multiplier multiplies a signal by a prescribed coefficient may be referred to as a ‘three-dimensional panning processing’. That is, the controller may give the related coefficient proper values corresponding to the respective output systems so that the resulting audio signal that is provided to the subject by means of the plurality of loudspeakers, has a shape and a location in space, e.g. an angle, distance, depth and height in relation to the subject. As a result of the processing of the multipliers, the sound is simulated properly for the propagation of direction and dimensions from the virtual sound source to the subject. The summations supply audio output signals of the multipliers to the respective output lines, each associated with a loudspeaker in a loudspeaker configuration.

Each output line may further comprise a signal attenuator having as attenuation coefficient:

a=1/N²

where N is the number of audio signal components yₙ in the signal distribution matrix and the obtained attenuation for a translates to a gain G in decibels as

G(dB)=10 log₁₀(a)

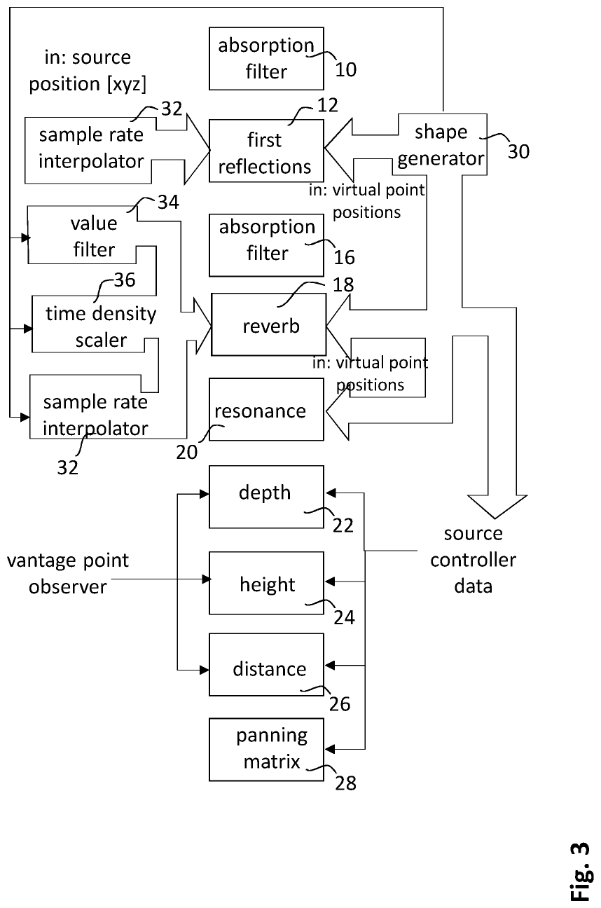

FIG. 3 is a flow chart illustrating the inputs for the respective modules described in FIG. 2 according to an embodiment.

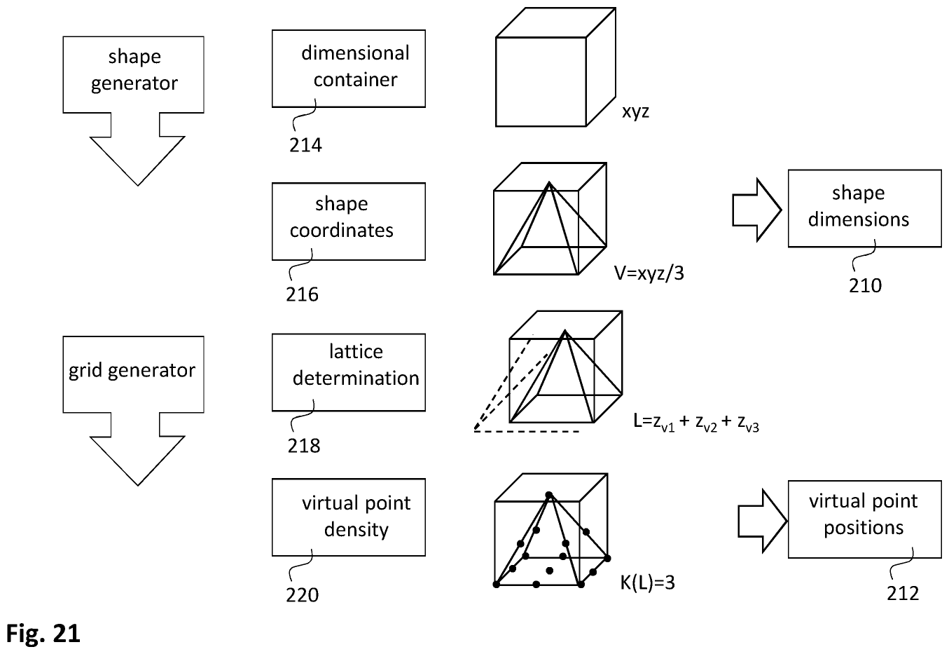

The method may comprise a shape generator 30 for determining the dimensions, position and orientation of the virtual object, which may also be referred to as “shape data”. The shape generator may output the set of virtual points constituting the virtual object, each virtual point in the set of virtual points being associated with a virtual position. The virtual points may be input to the respective modules as shown. The shape generator is further described below with reference to FIG. 21.

FIG. 21 illustrates a method to determine the representation defining the virtual object. The representation indicates the spatial dimensions of a virtual object, i.e. the shape and size and its position relative to the subject, and, optionally, the density of the virtual object.

The virtual points may be equally distributed over the surfaces or across the volume of the virtual object. A higher density of the virtual points on such surface or across such volume corresponds to a higher resolution.

It should be appreciated that the virtual object can be defined to be hollow. In such case, the representation does not define virtual points “inside” the virtual object, but only on the external surfaces and edges of the virtual object. The virtual object can also be “solid”. In such case, the representation defines, in addition to virtual points on the exterior surfaces and edges of the virtual object, virtual points “inside” the virtual object, which may be equally distributed across the interior volume of the virtual object.

In an embodiment, a virtual object has a geometric shape, i.e. a pure dimensional shape, or semi-geometric, irregular or may be organically shaped. It should be understood that the virtual object may have any form and that any method may be used to determine the shape of the virtual object and the virtual points constituting the shape of the virtual object.

The density of the virtual points may also be referred to as the resolution of the virtual points and/or the ‘grid resolution’.

FIG. 21 illustrates that obtaining the representation may comprise obtaining dimensions of the virtual object 210 and the virtual point positions 212. Obtaining the shape dimensions 210 may comprise a shape generator generating a container 214 of scalable dimensions (xyz) and determining shape coordinates 216 and a shape volume within the boundaries of the scaled dimensions to obtain the dimensions of the virtual object. In the depicted example, the virtual object is shaped as a pyramid. Furthermore, obtaining the virtual point positions 212, may comprise a grid generator determining a lattice 218, where three main lattices are introduced in accordance with the dimensions of chosen shape; and, determining the virtual point density 220 by defining a resolution of points along each of the introduced lattices, to obtain the virtual point positions within a shape.

An infinite lattice L can be defined as

L=a.(Z.v_1+Z.v_2+Z.v_3)

where Z is the ring of integers, and v_1, v_2 , v_3 describe three vectors and constant a relates to the minimal increment as

={points (x,y), such that x=a.n.(v_1.x)+a.m.(v_2.x), y=a.n.(v_1.y)+a.m.(v_2.y), with n, m integers.}

As it is considered that sound propagates symmetrically in all directions, the patterns of overlapping or tangent circles generated by the lattice is considered, where a sphere is centered around each virtual point of the grid. The radius of the circles may be increased to influence the generated patterns of the sound propagation in space.

In the depicted example, the lattice K=3 is shown, meaning that along each axis of the lattice three virtual points are defined.

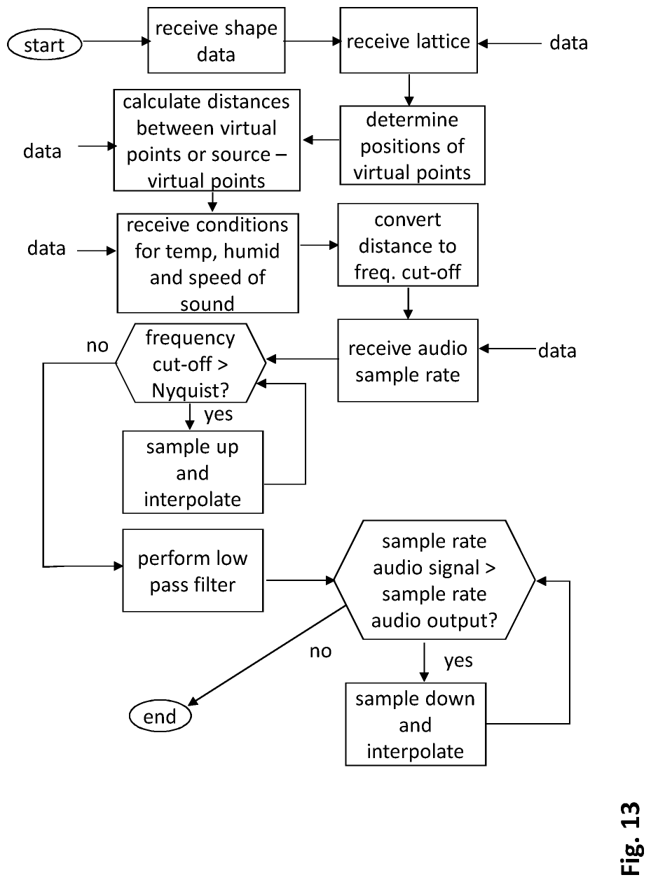

Furthermore, the method may comprise a ‘sample rate interpolator’ operation 32. This operation is preferably performed in dependence of position data (x, y, z) of the virtual input source to modify the signal process performed in first reflections module 12. The operation is also performed in dependence of obtained shape data and serves to modify and optimize the signal process of the reverb module 18. The sample rate interpolation is further described below with reference to FIG. 13.

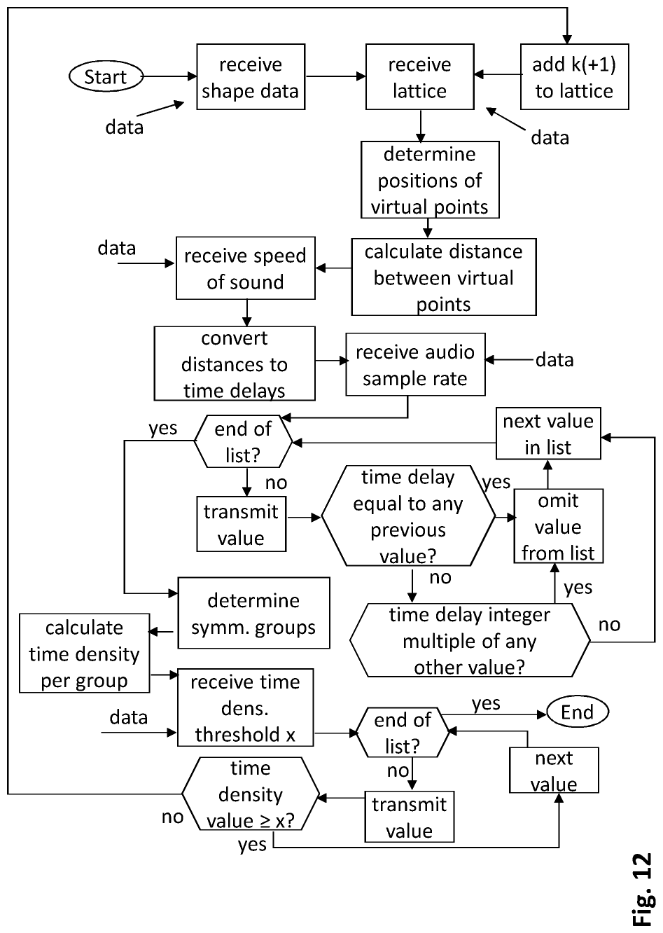

The method for generating a reverberation audio signal may also comprise a ‘value filter’ operation 34, a ‘time density scaler’ operation 36. These operations may be performed in dependence of obtained shape data and serve to modify and optimize the signal process of the reverb module 18. The operations 34 and 36 are further described below with reference to FIG. 12.

The method may further comprise obtaining controller data with regards to the input source position (x, y, z) and rotation (x, y, z) and a ‘vantage point’ which denotes the virtual and/or actual position of the listener and applying obtained data as an input for multiple modules of the digital signal process.

The described audio signal processing in FIG. 2 and the shape data acquisition and modification, sample rate interpolation, value filtering and time density scaling in FIG. 3 may be performed in real-time, e.g. by running a software programme or code portion.

One aspect of this disclosure relates to a data processing system that is configured to perform the method for generating a reverberation audio signal as described herein. Such data processing system may be connected to an audio output port; and, optionally, to an audio input port to acquire audio input signals in real-time.

It should be understood that an embodiment of the invention may include performing (part of) one, several and/or all of the modules described in FIG. 2 and FIG. 3; and that modules may be performed in a different order and/or may be repeatedly performed.

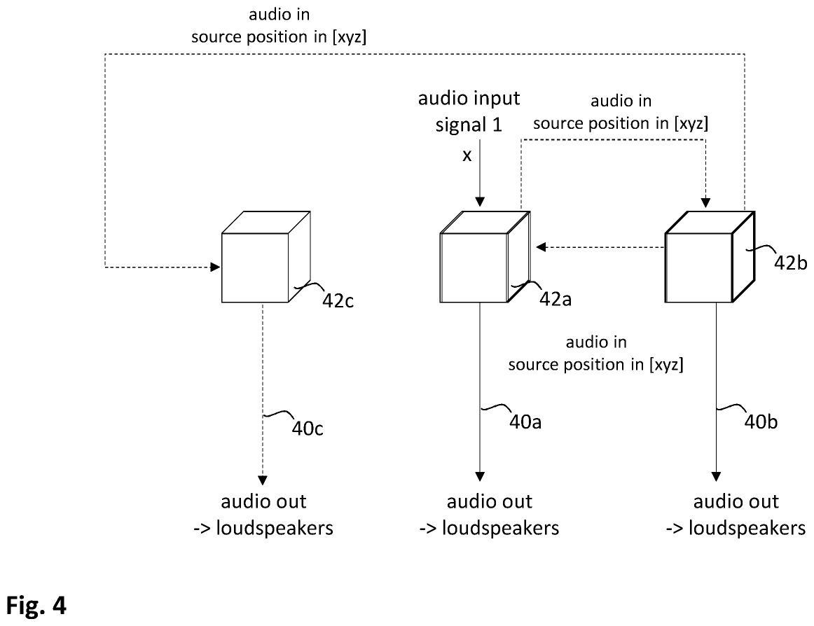

FIG. 4 illustrates a method for generating a reverberation audio signal according to an embodiment, wherein a further reverberation audio signal 40b is determined for a further virtual object by performing a method 42b, besides the determination of reverberation audio signal 40a by performing the method 42a. Even further reverberation audio signals may be generated, e.g. signal 40c, by performing method 42c. Herein, methods 42a, 42b, 42c may be methods for determining a reverberation audio signal as described herein. These methods may all for example be the method as shown in FIG. 2.

It should be appreciated that each method 42 indicated in FIG. 4 is associated with a combination of a virtual sound source and a virtual object.

In the embodiment depicted in FIG. 4, for the determination of further reverberation audio signal 40b, as input audio signal a signal is taken that is generated by the method 42a. Preferably, signal 21 as indicated in FIG. 2 is used as input audio signal for generating a further reverberation audio signal. However, in principle any signal that is generated while performing method 42a can be provided to method 42b as audio input signal. Preferably, method 42b also receives as input the virtual position of the virtual object associated with method 42a, i.e. the virtual object for which method 42a generates the reverberation audio signal 40a. This namely allows to determine the virtual positions of the virtual points of the virtual object associated with method 42b with respect to the “virtual sound source”, which source for method 42b is the virtual object associated with method 42a.

In turn, an even further method 42c for determining a reverberation audio signal 40c may be performed using as input audio signal any of the signals generated while performing method 42b, preferably, the signal 21 indicated in FIG. 2. In such case, method 42c also receives as input the position of the virtual object associated with method 42b, i.e. the virtual object for which the reverberation audio signal 40b is generated.

In principle, any number of signals may be the input for any number of methods 42_x for determining a reverberation audio signal, e.g. in a chain and/or simultaneously. A method for generating a reverberation audio signal may use a combination of signals as audio input signal.

While method 42a can generate a signal that is input for a further method 42b for generating a further reverberation audio signal, a signal generated while performing method 42b can at the same time generate a signal that is used as input audio signal for method 42a again. Thus, a feedback operation is enabled between methods 42a and 42b, where both objects respectively associated with these methods reflect into each other producing a reverberation in dependence of an audio input signal inserted initially in either of the methods 42a or 42b. Of course, each method 42a and 42b has as input its own shape data and the spatial position and rotation (x, y, z) because they are associated with different reverberation virtual objects.

Thus, a virtual object as referred to in this disclosure may form a virtual sound source as referred to in this disclosure for a further virtual object.

Embodiments as depicted in FIG. 4 thus enable to establish relationships between sound sources and virtual objects. A virtual object as used herein may be understood to virtually represent an object that reflects and reverberates sound from an excitation source, also referred to as “sound source” or “input source”.

It should be appreciated that the reverberation audio signal 40a and the further reverberation audio signal 40b, and optionally even further reverberation audio signals, such as signal 40c, may be combined in order to determine a final reverberation signal that can be fed, optionally via a panning system, to a set of one or more loudspeakers.

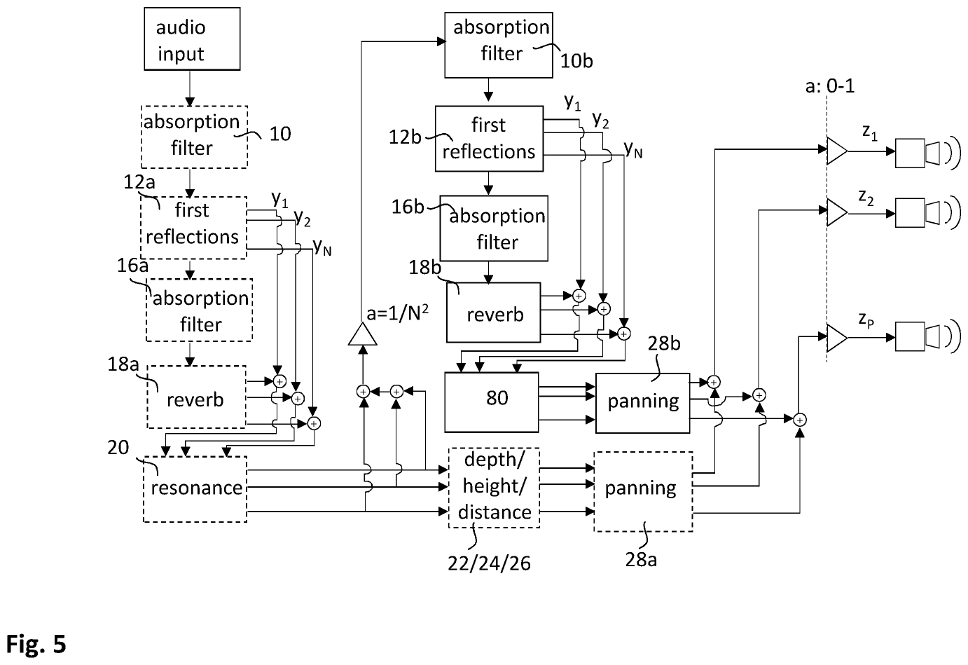

FIG. 5 illustrates an embodiment, wherein an audio input signal x is used as input audio signal for a first reverberation audio signal generating method according to an embodiment and wherein the resulting reverberation audio signal is subsequently used as input audio signal for a second reverberation audio signal generating method according to an embodiment.

Both methods generate discrete audio output signals z_p for each loudspeaker p in a loudspeaker configuration, which, before being fed to the loudspeakers are first summed and optionally attenuated and/or amplified with a multiplier ranging from 0-1.

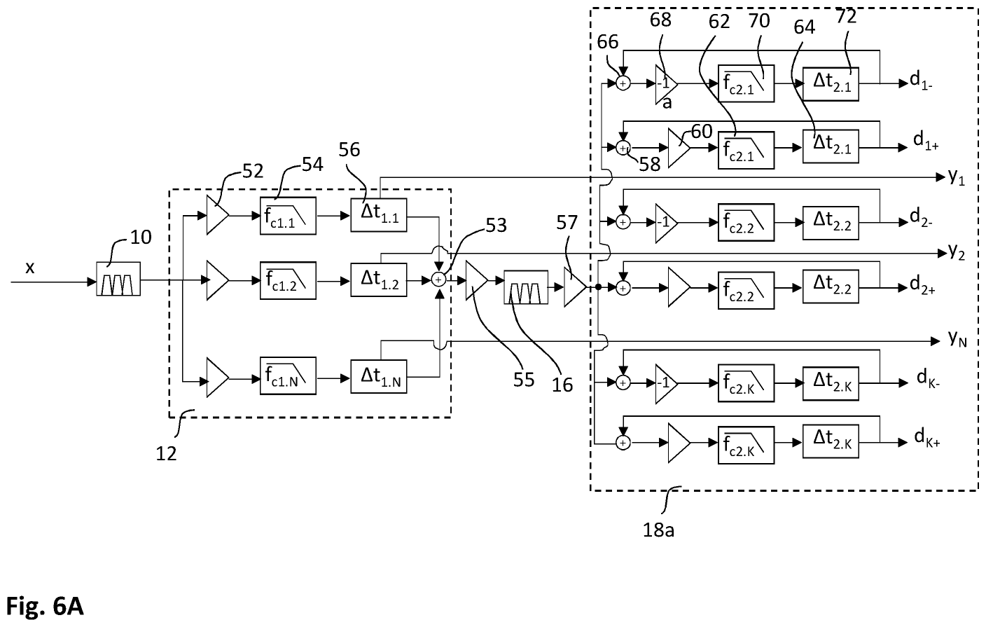

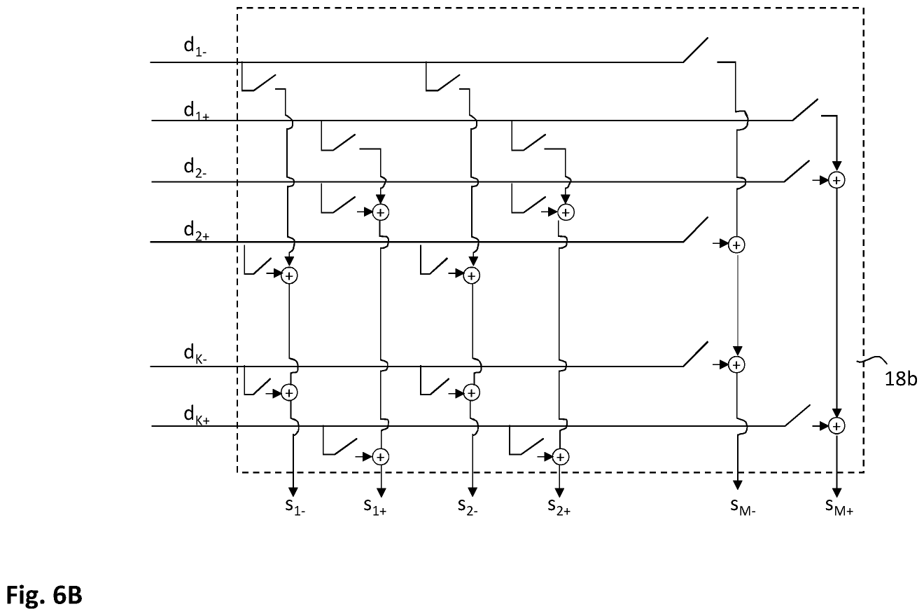

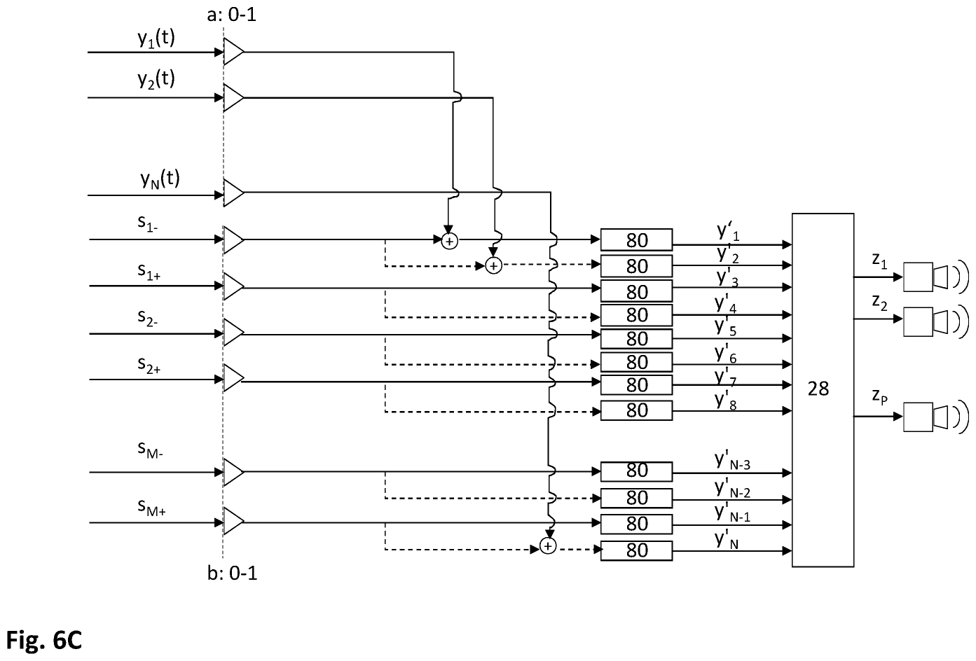

FIG. 6 is a detailed flow chart illustrating a reverberation audio signal generating method according to an embodiment. This embodiment comprises receiving an input audio signal (see left hand side of FIG. 6). The input audio signal optionally is the sum of audio signal components that have been determined while performing another reverberation audio signal generating method according to an embodiment, as described in FIG. 5.

The embodiment of FIG. 6 comprises providing the input audio signal to a multi-band filter 10 (also see FIG. 2). Hence, this embodiment comprises filtering the input audio signal which comprises applying a multi-band filter 10. Applying multi-band filter 10 comprises attenuating respective frequency bands in the input audio signal using respective attenuation coefficients, wherein the respective attenuation coefficients are determined based on a material of the virtual object.

In a particular example, the multi-band filter consists of an 8-octave band equalizer for which the attenuation coefficients a(dB) are determined individually for each frequency band f. The values for the attenuation coefficients are given by the standard equation converting dB to power ratio

G(dB)=10 log₁₀(Pt/Pi)

where Pt is the power level and Pi(1) is a referenced power level. G(dB) is the power ratio or gain in dB a(dB)=G(dB) and the power ratio converts to an absorption coefficient as

α=1−(Pt/Pi)

The value for α may be obtained from the standard ISO354 for absorption coefficients, the data comprising standardized methods for material testing (Bork, 2005b).

In an embodiment, the virtual object is a limestone wall. The octave bands in frequency f(Hz) are given by the random incidence absorption coefficient α for limestone walls in the ISO354:

f(125Hz)α=0.02,

f(250Hz)α=0.02,

f(500Hz)α=0.03,

f(1000Hz)α=0.04,

(f2000Hz)α=0.05,

(f4000Hz)α=0.05,

(f8000Hz)α=0.05,

f(16000Hz)α=0.05,

By applying the attenuation a(dB) for each octave band in frequency f(Hz), an input audio signal is modified so that the difference of the one-sided intensity of the reflected sound (Ir˜Pt) and the one-sided intensity of the incident sound (Ii˜Pi) is the absorption of energy of the sound by a limestone wall. The resulting reverberation will thus constitute characteristics of a distinct materiality.

The method further comprises (in first reflections module 12, also see FIG. 2) determining for each virtual point of the virtual object, based on the filtered version of the input audio signal, a virtual point audio signal component y(t)_n. Herein, determining each virtual point audio signal component y(t)_n comprises performing a virtual-point-specific operation on the (filtered) audio input signal. In the depicted embodiment, the virtual-point-specific operation comprises performing an attenuation operation 52 for attenuating a signal, a low-pass filter operation 54 for filtering out higher frequencies than a threshold frequency and a time delay operation 56 for introducing a time delay. As used herein, filtering out frequencies above or below a threshold frequency, also referred to as cut-off frequencies, may be understood to be attenuating frequencies with gradual increase up until and above, or respectively, up until and below such threshold frequencies. Filtering out thus does not mean that frequencies higher, or respectively, lower than the cut-off frequency are completely removed and/or not removed.

The first reflections module 12 generates the first reflections of the sound. Each audio signal component yₙ is associated with a discrete virtual point of the virtual object. Further, each virtual point audio signal component yₙ is determined based on the virtual position of its associated virtual point, in particular based on its virtual distance from a virtual sound source. The generated reverberation audio signal may namely be understood to reflect an audio signal that originates from this virtual sound source. The position of this virtual sound source is defined, for example, in the virtual representation of the virtual object.

It should be understood the attenuation operation 52, the low-pass filtering operation 54 and the time delay operation 56 for each virtual point may be performed in any order; and that one or more steps may be omitted, repeated, modified and/or added.

The attenuation a(dB) in operation 52 of the audio signal component y_n in dependence of the distance r between the associated virtual point and sound source is given by converting G->Pt/Pi and

Pt=x(1/r²)

where the sound intensity is given by I˜Pt² and x is a multiplication factor between 0-1 for controlling the amount of attenuation applied.

It should be understood that an optional multiplication factor x, a ‘scaler’ may be added at any other step in the described audio signal process to provide a parameter scaling function, and that this scaler may be performed by a user sending controller data to modify aspects of the sounding output of the reverberation, i.e. increasing or decreasing the output values, thus enlarging or diminishing the effects of the operation.

The low-pass filter 54 constitutes a damping function of the audio signal component yₙ in dependence of the distance r between the virtual point and the virtual sound source, where the attenuation a(dB/m) of frequency f(Hz) is a function of the absorption of sound propagating through a medium, comprising the high-frequency dissipation of the sound before its reflection.

The cut-off frequency f_{c} of the low-pass filter 54 is generally defined as the frequency at which the sound pressure amplitude ratio of output to input has a magnitude of 0.707, where

ΔLₜ=20 log(Pₜ/Pᵢ)[dB] is the Sound Pressure Level (SPL)

and

ΔLₜ=20 log(Pₜ/Pᵢ)=10 log 0.707˜3dB

and

a(dB/m)=−3/r

In an embodiment, the propagation medium of sound within a space is air at a given temperature and a given humidity. It is possible to determine the frequency as a function of the attenuation by rearranging the equation for atmospheric absorption of sound

$$f = \sqrt{\frac{a}{8.686 \times ( {( 1.84 \times {10}^{- 11} \times {( \frac{{p}_{a}}{{p}_{r}} )}^{- 1} \times \frac{T}{{T}_{o}} )}^{1 / 2} ) + y )}} [ H z ]$$

where pₐ is the ambient atmospheric pressure in kPa, pᵣ=101.325 kPa is the reference ambient atmospheric pressure, T is the ambient atmospheric temperature, and T₀=293.15K is the reference ambient atmospheric temperature.

$$\begin{matrix}y = {( \frac{T}{{T}_{o}} )}^{5 / 2} \times ( 0.01275 \times {e}^{- 2239.1 / T} \times {( {f}_{r O} + \frac{{f}^{2}}{{f}_{r O}} )}^{- 1} + z ) \\ z = 0.1068 \times {e}^{- 3352 / T} \times {( {f}_{rN} + \frac{{f}^{2}}{{f}_{r 𝒩}} )}^{- 1} \\ {f}_{r O} = \frac{{p}_{a}}{{p}_{r}} \times ( 24 + 4.04 \times 1 {0}^{4} \times h \times \frac{( 0.02 + h )}{( 0.391 + h )} ) [ H z ]\end{matrix}$$

is the oxygen relaxation frequency

$${f}_{r 𝒩} = \frac{{p}_{a}}{{p}_{r}} \times \sqrt{\frac{{T}_{o}}{T}} \times ( 9 + 280 \times h \times {e}^{( - 4.17 x ( {( T / {T}_{o} )}^{- 1 / 3} - 1 ) )} ) [ H z ]$$

is the nitrogen relaxation frequency

$$h = {h}_{r} \times \frac{{p}_{sat}}{{p}_{a}} [ \% ]$$

is the molar concentration of water vapor

$${P}_{sat} = {p}_{r} \times 1 {0}^{( - 6.8346 \times {( {T}_{ol} / T )}^{1.261} + 4.6151 )} [ kPa ]$$

is the saturation vapor pressure where hᵣ is the relative humidity as a percentage and Tₒₗ=273.16K is the triple-point isotherm temperature (Zuckerwar, Meredith, 1984).

An approximate solution to the equation defining the frequency f can be derived from first principles if the frequency f is inherent in a sinusoidal equation and the attenuation a in terms of the exponent which has a dependency on the frequency, i.e.

y=A=A₀e^{-a} cos(wt)

where A is the amplitude in dB, A₀ is the initial amplitude in dB and a is the attenuation coefficient in dB/m.

Rearranging a(dB/m)->α

a(dB/m)=10 log₁₀(Pt/Pi)

and

α=1−(Pt/Pi)

and analyzing the absorption coefficient as a function of frequency we find a polynomial of order=3 as a minimum. From analyzing both the absorption coefficient and the frequency separately we find the absorption coefficient is as follows

α=0.02e^{0.97n}

and the frequency as

f=62.5e^{0.7n}

where n is the data point. Combining the two equations we find

$$α = y \sqrt{2} {f}^{\sqrt{2}}$$

where y is a coefficient specific to external variables such as temperature and humidity. To achieve a maximum correlation with the absorption coefficient at higher frequencies we find the coefficient averages

y˜5×10⁻⁸

and varying for different conditions of temperature and humidity.

Rearranging the formula to obtain the frequency (f=f_{c}) as a function of the absorption coefficient gives

$$f = {( \frac{α}{y \sqrt{2}} )}^{( \frac{1}{\sqrt{2}} )}$$

and the correction factors y for different temperatures and humidity are e.g.

| temperature | hr, relative humidity (%) | y |
|---|---|---|
| 0° | 30.000% | 5.352E−05 |
| | 50.000% | 4.425E−05 |
| | 70.000% | 3.928E−05 |
| | 90.000% | 3.594E−05 |
| 10° | 30.000% | 6.089E−05 |
| | 50.000% | 5.107E−05 |
| | 70.000% | 4.504E−05 |
| | 90.000% | 4.069E−05 |
| 20° | 30.000% | 7.132E−05 |
| | 50.000% | 5.853E−05 |
| | 70.000% | 5.068E−05 |
| | 90.000% | 4.537E−05 |
| 30° | 30.000% | 8.232E−05 |
| | 50.000% | 6.627E−05 |
| | 70.000% | 5.730E−05 |
| | 90.000% | 5.147E−05 |

The time delay operation 56 for each virtual point audio signal component yₙ introduce a time delay Δtₙ (ms) in dependence of the distance r as given by

Δt(ms)=(r/v)10³

where v is the speed of sound propagating through a medium, f.i. 343 m/sec in air at a temperature of 20 C and an average 50% humidity and r is the distance between the virtual point and the virtual sound source, in particular between the virtual point and the center of the virtual sound source.

Thus, by applying, for each virtual point of the virtual object, the virtual-point-specific operation comprising the attenuation operation 52, low-pass filter operation 54 and time delay operation 56, virtual point audio signal components yₙ are generated. The components yₙ resemble first reflections of sound originating from a sound source and reflected by the virtual object in dependence of the position of the virtual object with respect to the sound source. Preferably, the components yₙ are also determined in accordance with conditions that influence the propagation of sound through a medium, such as the atmosphere of a certain temperature and humidity.

The virtual point audio signal components yₙ, also referred to as y(t)_n, resulting from the first reflections operation 12 are (i) passed as audio signal components to be summed with the symmetry group audio signals resulting from the reverb operation 18, as shown in FIG. 6C; and (ii) summed (see combiner 53) to obtain a composite audio signal.

Subsequently, the composite audio signal may be attenuated (see attenuation operation 55) by a factor a=1/N², wherein N is the number of virtual point audio signal components. Herein, N is the number of audio signal components and the attenuation a(dB)=G(dB) translates to G—>Pt/Pi where the power ratio is given in dB in terms of the gain G.

It should be understood that wherever two or more audio signals are summed within the described audio signal process, the above attenuation operation in dependence of the number of summed audio signals may be applied.

The composite audio signal is then filtered by performing a second multi-band filtering operation 16, which may be an absorption filter as described above. The values chosen for the first absorption filter 10 from the ISO354 are preferably the same values for the second absorption filter 16.

The filtered composite audio signal is then attenuated by performing an attenuation operation 57. This may be understood to be the same operation as operation 55, with the difference that the attenuation is dependent on the number of distinct distances in the further set of one or more distances K as

a=1/K².

The embodiment further comprises determining the one or more distance audio signal d_k as described herein, in this example two distance audio signals per distinct distance in the further set of one or more distances, namely a first distance audio signal d_k+ and a second distance audio signal d_k−.

Herein, determining the first distance audio signal for a distinct distance comprises modifying the composite audio signal by performing a time delay operation 64 introducing a time delay and a signal feedback operation 58. Determining the first distance audio signal also comprises performing an attenuation operation 60 and a low-pass filter operation 62.

In the depicted embodiment, determining the second distance audio signal for a distinct distance comprises modifying the composite audio signal by performing a second time delay operation 72 introducing a second time delay, a signal inverting operation 68, a signal attenuation operation 68, a low pass filter operation 70 and a second signal feedback operation 66. In principle, operations 64 and 72 are identical, operations 62 and 70 are identical. Also the attenuation performed by respectively operation 60 and 68 is identical, with note being taken that operation 68 inverts the signal and operation 60 does not.

Performing a signal feedback operation may involve recursively adding the distance audio signal back to the input itself before the attenuation operation, for example as shown. It should be appreciated that box 18a may be part of the reverb module 18 shown in FIG. 2.

It should be understood that in the determination of a distance audio signal d_k+−, the attenuation operation, signal inverting operation (if performed), low-pass filtering operation and time delay operation may be performed in any order; and, that one or more steps may be omitted, repeated, modified and/or added. The signal feedback operation is preferably performed last, and the summation of the distance audio signal and the input is preferably performed first.

Note that in the depicted embodiment 2K distance audio signals are generated.

The first distance audio signal for a distinct distance may be referred to as the non-inverted distance audio signal and the second distance audio signal for the distinct distance may be referred to as the inverted distance audio signal.

The time delay operation 64/72 introduces a time delay Δtₙ (ms) in dependence of the distance for which the distance audio signal is determined. This time delay is given by

Δt(ms)=(r/v)10³

wherein r is the distance for which the distance audio signal d_k is determined and v is the speed of sound propagating through a medium, e.g. 343 m/sec in air at a temperature of 20 C and an average 50% humidity.

The low-pass filter operation 62/70 constitutes a damping function distance audio signal in dependence of the distance for which the distance audio signal d_k is determined and the conditions for sound propagating through a medium, as described above for operation 54 with the difference that as distance r the distance should be taken for which the distance audio signal is determined.

The attenuation operation 60/68 is performed in dependence of the time delay Δtₙ introduced by time delay operation 64/72 as

a(dB)=−Δtx

where x is a variable of the total decay time of the reverberation audio signal Dt(s) and the attenuation constant e^{ax}

x=(1/Dt)/e^{ax}

e^{ax} is the attenuation constant for waves propagating through a medium per unit distance from the source. (Federal Standard 1037C, 1996) It is the real part of the propagation constant and is also measured in nepers per metre (Np/m). A neper is approximately ˜8.686 dB. The attenuation constant thus can be defined by the amplitude ratio

e^{ax}=A₀/Aₓ=1Np=˜8.686

The value Dt (in sec.) determines the real time for the total energy of the reverberation audio signal to decay. If the lower loudness threshold of hearing is considered at a standard of −72 dB the above formula may be adjusted for practical purposes to

x=˜½(1/Dt)/e^{ax}

As a result, the real amplitude A of each distance audio signal after applying the attenuation a(dB) will differ based on the delay time length Δt where typically the shorter the length the higher the initial amplitude; and furthermore, may differ greatly based on the frequencies fn present in the audio input signal, as a fundamental frequency F and its harmonics being multiple integers F(f1, f2, f3, etc.) relate to the time delay of the feedback operation as

F(Hz)=1/(2Δt)

but the time magnitude M(t) of the feedback of each distance audio signal will be equal for each distance audio signal at the loudness threshold of −72 dB and thus the magnitude M(t) of each distance audio signal equals Dt(s). This condition satisfies the required density of the reverb to remain constant during its total time to decay.

In an embodiment, a virtual object has the shape of a round chapel and this chapel has walls made from limestone. One has determined that this virtual space has an audible reverberation decay time of ˜2.2 seconds and thus Dt(2.2) is applied to modify all distance audio signals.

Additionally, the attenuation operation 60/68 may be further modified in dependence of a correction of the high-frequency dissipation that results from the absorption of sound propagating through a medium, i.e. the higher frequencies dissipating relatively faster than the lower frequencies during the decay of the reverb, and thus the shorter the delay time Δt the time magnitude M(t) may be further reduced. This is achieved by increasing the attenuation a(dB) as

a(dB)=x−(Δtₒ/Δtn)x

where x is a variable function of the total decay time Dt, Δto is a reference time delay, which is the longest time delay in the system, i.e. the longest time delay that is used in block 18a depicted in FIG. 6A. As a result, the attenuation for delay line with time delay Δtn=Δto equals 0.

Combining the two formulas gives

a(dB)=x−(Δtₙx)−(Δtₒ/Δtₙ)x

Thus, by applying the attenuation operation, the low-pass filter operation and the time delay operation, audio signal components are generated that, once summed, resemble a coherent reverberation of a sound source in a space and/or object of a distinct shape, size and materiality; and, according to conditions that influence the propagation of sound through a medium, such as the atmosphere of a certain temperature and humidity.

FIG. 6B is a flow chart illustrating how the symmetry group audio signals s_m+− are determined on the basis of the distance audio signals d_k+− according to an embodiment. This embodiment comprises determining, for each symmetry group m, a first symmetry group audio signal and a second symmetry group audio signal. Further, determining the first and second symmetry group audio signals comprises, selecting a distance audio signal out of every pair of first and second distance audio signal, each pair having been determined for a respective distance out of the set of one or more symmetry group distances associated with the symmetry group in question, and combining the selected distance audio signals in order to determine the first symmetry group audio signal and combining the non-selected distance audio signals out of every pair of first and second distance audio signal in order to determine the second symmetry group audio signal.

To illustrate, for the determination of s_1−, the distance audio signal d_1− and distance audio signal d_2+ (and other signals) are combined. Hence, for the determination of s_1+, the distance audio signal d_1+ and d_2− (and other signals) are combined. Note that this implies that the distance associated with distance audio signal d_1 and the distance associated with distance audio signal d_2 are present in the set of one or more symmetry group distances for group m=1, for which s_1− and s_1+ are the symmetry group audio signals. If these distances would not be in the set of symmetry group distances for symmetry group m=1, then these would not be added to s_1− nor to s_1+.

In an embodiment, a the virtual object is a hollow cube of 40×40×40 m with a lattice k(=3) which gives 54 points defined on the shape, that is a ‘virtual point resolution’ of 3×3 points equally distributed on the 6 surfaces of the cube. In this embodiment, the further set of one or more distances comprises 18 distinct distances. Each distinct distance is associated with a unique delay time Δt and generated relating to a speed of sound 343 m/sec, i.e. the propagation of sound through air at a temperature of 20 C and average humidity of 50%. Thus, each pair of distance audio signals is associated with a distinct distance in the further set of one or more distances. As a reminder, the further set of one or more distances as referred to in this disclosure comprises all distances in all sets of one or more symmetry group distances. Each set of one or more symmetry group distances is associated with a symmetry group. In this embodiment, each virtual point of the virtual object belongs to one of 3 symmetry groups. The resulting audio distribution matrix to perform the summation of inverted and not-inverted versions of the distance audio signals for the cube may thus be defined in accordance with the below table. Herein, the columns show the symmetry group signals 1.1 (s_1−), 1.2 (s_1+) for symmetry group 1, symmetry group signals 2.1 (s_2−), 2.2 (s_2+) for symmetry group 2 and symmetry group signal 3.1 (s_M−), 3.2 (s_M+) for symmetry group 3, where the amount of symmetry groups in this embodiment is M=3. Each row in this column relates to a distinct distance in the further set of one or more distances. Herein, the distances are indicated by associated time delays.

| | Groups (g) | | | | | |
|---|---|---|---|---|---|---|
| Δt (ms) | 1.1 | 1.2 | 2.1 | 2.2 | 3.1 | 3.2 |
| 27.487 | −1 | +1 | −1 | +1 | 0 | 0 |
| 38.873 | +1 | −1 | +1 | −1 | +1 | −1 |
| 47.609 | −1 | +1 | −1 | +1 | 0 | 0 |
| 54.974 | 0 | 0 | 0 | 0 | 1 | −1 |
| 61.463 | −1 | +1 | −1 | +1 | −1 | +1 |
| 72.724 | +1 | −1 | +1 | −1 | +1 | −1 |
| 82.461 | 0 | 0 | 0 | 0 | −1 | +1 |
| 86.922 | +1 | −1 | +1 | −1 | 0 | 0 |
| 91.165 | 0 | 0 | −1 | +1 | −1 | +1 |
| 99.106 | +1 | −1 | +1 | −1 | 0 | 0 |
| 106.457 | −1 | +1 | −1 | +1 | 0 | 0 |
| 113.332 | +1 | −1 | +1 | −1 | +1 | −1 |
| 119.814 | −1 | +1 | −1 | +1 | −1 | +1 |
| 125.962 | +1 | −1 | 0 | 0 | 0 | 0 |
| 128.926 | −1 | +1 | −1 | +1 | −1 | +1 |
| 140.157 | +1 | −1 | +1 | −1 | 0 | 0 |
| 157.902 | −1 | +1 | 0 | 0 | 0 | 0 |
| 160.276 | +1 | −1 | 0 | 0 | 0 | 0 |

This table should thus be read as that for the determination of symmetry group audio signal 1.1, the inverted version of distance audio signal for distance “27.487 ms”, and the non-inverted version of distance audio signal for distance “38.873 ms”, and the inverted version of distance audio signal for distance “47.609”, et cetera are added together to form symmetry group signal 1.1.

Note that the method for determining symmetry group audio signal based on distance audio signal as depicted in FIG. 6B is preferably implemented in reverb module 18 shown in FIG. 2.

FIG. 6C is a detailed flow chart illustrating how the reverberation audio signal is determined based on the symmetry group audio signals s_m and the virtual point audio signal components y_n.

Optionally, determining the reverberation audio signal comprises combining the symmetry group audio signals with the virtual point audio signal components. Optionally, such combination comprises determining modified audio signal components, wherein determining modified audio signal components comprises adding, to each virtual point audio signal component determined for a virtual point belonging to a symmetry group, the symmetry group audio signal of the symmetry group in question. To illustrate, in FIG. 6C, in this way a modified audio signal component y′ₙ is obtained for each virtual point of the virtual object. Optionally, determining the modified components y′ₙ comprises attenuating the virtual point audio signal components and/or the symmetry group audio signals, for example before adding the symmetry group audio signals to the virtual point audio signal components as shown in FIG. 6C.

The optional attenuation of virtual point audio signal components is controlled by variable parameter a, comprising a gain(dB) scaled from 0-1 (∞-0 dB line-out). The optional attenuation of symmetry group audio signals is controlled by variable parameter b comprising a gain(dB) scaled from 0-1. This provides a user with optional control for adjustment of the respective audio output levels of the first reflections and the reverberation of a sound source independently. It should be understood that an additional multiplier to attenuate or amplify the gain of an audio signal may be added at any point in the signal process described in FIG. 6A-C.

Each modified audio signal component y′_n obtained after the summation, e.g. combination of a virtual point audio signal component and a symmetry group audio signal should be understood to be associated with a virtual point of the virtual object.

Optionally, each audio signal obtained after adding the appropriate symmetry group audio signal to a virtual point audio signal component is further modified. Thus, in such embodiment, determining the modified audio signal components may also comprise further modifications, such as by a resonance module, depth module, height module and/or distance module as present in module 80 (see FIG. 2) as described above with reference to FIG. 16.

The modified audio signal components y′ₙ that are eventually obtained, each associated with a virtual point of the virtual object are the input to a panning system, such as a panning matrix 28, to distribute modified audio signal components y′ₙ to form discrete audio output signals z_p, each associated with a loudspeaker p in a loudspeaker configuration. FIG. 17 shows a detailed embodiment of a panning system.

An advantage of applying the operations as part of the reverb operation 18, the resonance operation 20, the depth operation 22, the height operation 24, the distance operation 26 and the panning matrix operation 28, is that a coherent sound projection is generated of a sound source reflecting from a virtual object, where both the sound source and the virtual object are independently controllable and scalable with respect to the actual output medium, i.e. the loudspeakers. This means that the experience of a dynamic virtual space, that can be constructed by defining a plurality of virtual objects as described herein, the listener can move within and explore auditorily, does principally not depend on the amount and configuration of the loudspeakers. Thus, the sound source and the virtual object can be scaled, rotated, tilted, (parts of) the space can be magnified in close-up or far-away, and can be positioned at any distance, height and depth in relation to the observer, and in relation to the virtual sound source and/or the virtual sound source/virtual object to another virtual object, without the need to reconfigure the loudspeakers.

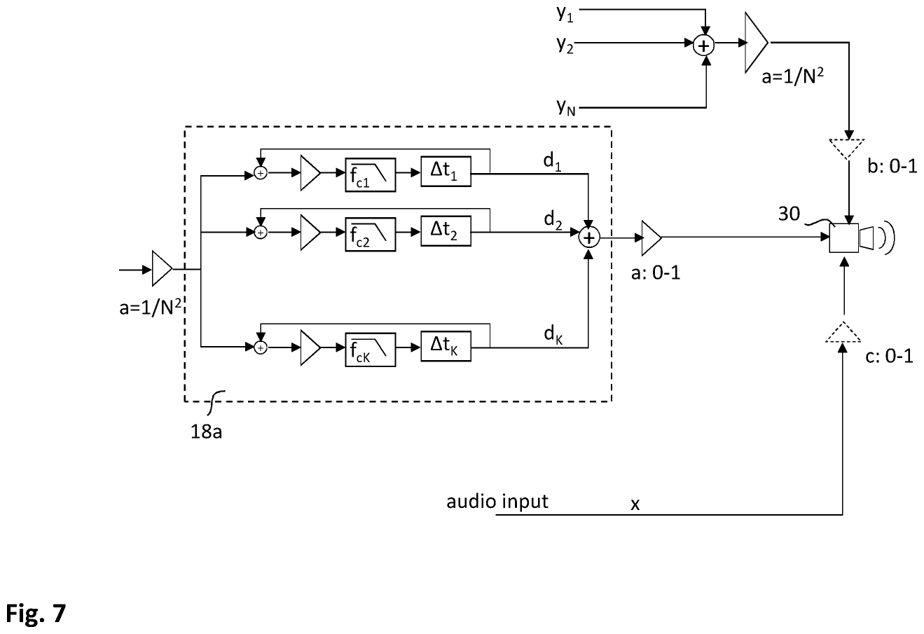

FIG. 7 illustrates an embodiment where a loudspeaker configuration is a mono sound system, i.e. a loudspeaker system with one discrete output channel. In this case, in the reverb operation 18 as described in FIG. 6A only an inverted or not-inverted version is generated for each distance audio signal based on the composite audio signal. In such embodiment, determining the symmetry group audio signals may be omitted in its entirety in this case. Instead, all determined distance audios signals d_k resulting from the reverb operation 18a may be summed and optionally attenuated or amplified; and all virtual point audio signal components y_n resulting from the first reflections operation 12 may be summed, attenuated using the formula in dependence of the number of summed audio signals, and optionally further attenuated or amplified; and summed in the audio output of a loudspeaker together with the audio signal resulting from summing the distance audio signals, and together with the audio input signal x, which may also serve as audio input signal for a further reverberation audio signal determination method, as described with reference to FIG. 2, FIG. 5 and FIG. 6A.

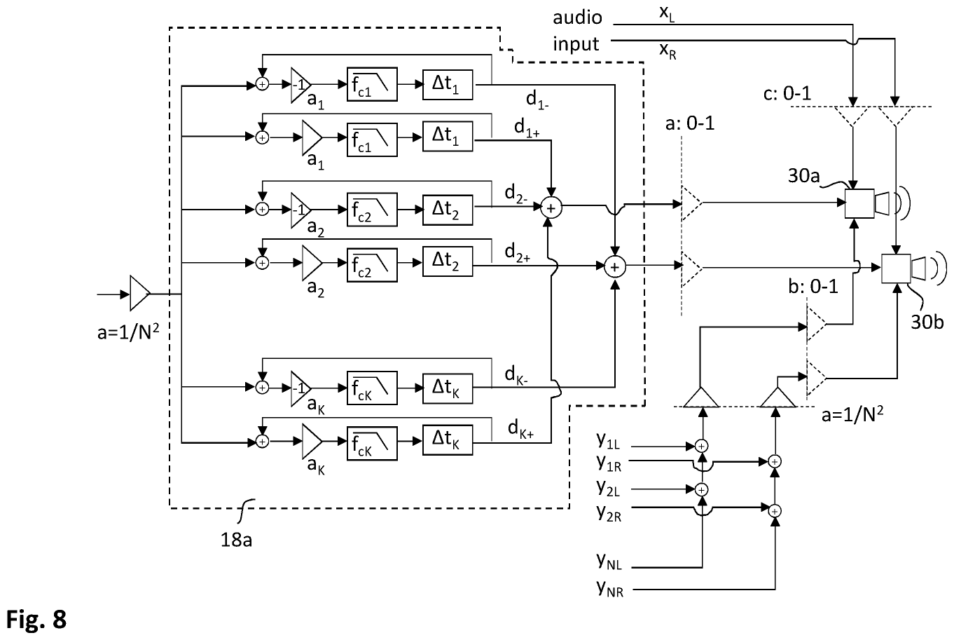

FIG. 8 illustrates an embodiment where a loudspeaker configuration is a stereo sound system, i.e. a loudspeaker system with two discrete output channels comprising the left (L) 30a and right (R) 30b side of a speaker setup in respect to the left and right-side ears of a (virtual) listener positioned in the middle. In an embodiment, such a system may be a pair of headphones. In this case, with respect to the reverb operation as described in FIG. 6A both the inverted and not-inverted versions for each distance audio signal is determined. In this embodiment, the determination of symmetry group audio signals may be omitted in its entirety. Instead, the output of the first inverted version of a delay line is summed with the non-inverted version of the second delay line, the inverted version of the third delay line, etc. to form a discrete left-side output signal (L); and, the output of the first not-inverted version of a delay line is summed with the inverted version of the second delay line, the not-inverted version of the third delay line, etc. to form a discrete right-side output signal (R). With regards to the output of R, the output of L≠R and both L and R output signals may further be optionally attenuated or amplified before being fed to the L and R loudspeakers.

In this example, an audio input signal x which is the input audio signal for a reverberation audio signal determination method described herein is defined as a stereo signal with a L and a R channel, where either L=R or L≠R may be true. Both L and R output signals of the initial audio input signal may further be optionally attenuated or amplified before being fed to the L and R loudspeakers.

As a result, for all virtual point audio signal components resulting from the first reflections operation 12, a L and a R version of the delay line for each delay time Δt is generated, where either L=R or L≠R may be true. All L versions of the virtual point audio signal components resulting from the first reflections operation 12 are then summed, and all R version are summed, and both L and R are attenuated using the formula in dependence of the number of summed audio signals, and optionally further attenuated or amplified before being fed to the L and R loudspeakers.

It should be understood that FIG. 7 and FIG. 8 represent possible embodiments which show the application of the described invention with regards to its backward compatibility with existing audio standards. Any variation of the output routing with regards to the audio signal process as described adjusted to a prior-art standard should be considered included herein.

The virtual points of the virtual object belong to symmetry groups of virtual points that can be determined as described in FIG. 9. The virtual points are preferably equally distributed throughout and/or on the virtual object.

A number N of virtual points may be defined and the virtual points may be understood to define the virtual object. In an embodiment, the virtual object is a square plate as shown in FIG. 9, being a 2-dimensional shape with N=25 equally distributed virtual points defined on the shape. In this example, the center point of the square plate coincides with virtual point #13. Since it is a square plate, a 90 degrees rotation around the center point will yield the same configuration again, i.e. square plate having the same position and orientation.

The top right picture in FIG. 9 indicates for each virtual point to which symmetry group it belongs, i.e the figures between brackets indicate the symmetry groups for the virtual points. In this example, there are six symmetry groups. As can be seen in FIG. 9, a single point, in FIG. 9 virtual point #13 belonging to symmetry group g₆, may form its own symmetry group in an embodiment. In case of non-geometrical or more irregularly formed shapes, due to the lack of rotational symmetry several or many single points may form their own symmetry group in an embodiment. Thus it follows that geometrical or regular polygonal shapes tend to have fewer symmetry groups containing many points and irregular shapes tend to have more symmetry groups containing less points, i.e. a minimum of one point.

Every virtual point n defined on the shape thus belongs to one symmetry group g. This constitutes that the conditions of the reverberation in the virtual object at the virtual points contained in one-and-the-same symmetry group will be the same, and that the virtual points contained in this symmetry group share the identical set of distances to any other points defined on the shape.

Each symmetry group is associated with a set of one or more symmetry group distances. FIG. 9 shows for each of the symmetry groups 1, 2, 3, 4, 5, 6, the associated symmetry group distances.

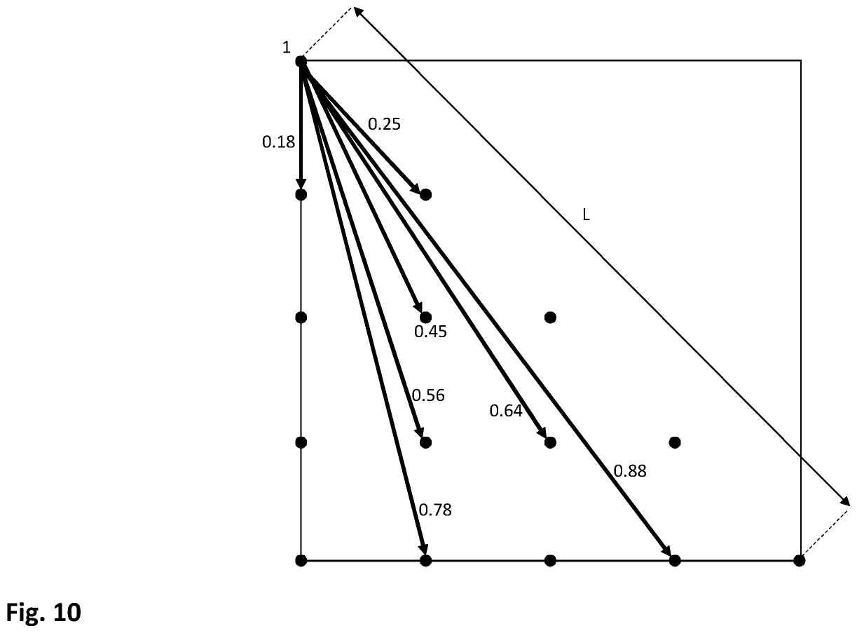

As can be seen from the FIG. 9, a symmetry group gn may have more or less distances r_{g(n)<->n} than other groups, and many groups may share identical distances r_{n<->n} with other groups. In the example of the square plate of FIG. 9, there are seven distinct distances in the further set of one or more distances. These seven distances in the further set of one or more distances are shown in FIG. 10.

In an embodiment, a shape is a square plate with lattice k(=5) and edges of length l(m) and where L=√2I=1 m and sound propagates through the plate with a speed v=343 m/sec. As follows from the method introduced in FIG. 9, a total of 7 distinct distances are present in the set of one or more further distances. Each distinct distance is associated with a time delay Δt(ms)=(rn<->n/v)10³.

With regards to the number of virtual points defined for a virtual object and following the example described in FIG. 10, the described method comprises a highly efficient way to reduce the computational overhead required for generating a reverberation audio signal with desired coherence, density and smoothness, without losing the essential information that is unique to a virtual object of a particular shape and/or a particular size and materiality.

For example, a straight-forward signal path for each distance between all existing pairs of virtual points of a virtual object, being a square plate with 25 virtual points as introduced in FIG. 9, would add up to 25×24 =600 distances associated with 600 distance audio signals or even 1200 distance audio signals if two distance audio signals are determined for each distance, to theoretically be able to produce a first order of reflections of the reverberation after the first reflections from the virtual sound source to the virtual object. Furthermore, the sum of the distance audio signals would not satisfy the criteria for smoothness of the reverberation tail; that is, a reverberation tail that would be generated by a feedback operation, such as described in FIG. 6A; or more in general, a feedback-delay network (FDN) as is common to produce reverberation in the prior-art. The smoothness criteria for the modal density of the reverb is generally described to resemble a pink-noise signal with a faster dissipation of the higher frequencies compared to the lower frequencies in the time dimension. Since many identical and integer multiples of distances would be found among the set of distances generated as such, this would result in a dominance of certain frequencies F which disbalances the smoothness of the tail across the frequency range. Therefore such an approach to generate the reverberation tail would be disregarded in prior-art methods, as it would not satisfy the predetermined conditions.

Instead, following the proposed method as described with reference to FIG. 9, the number of signal paths required is greatly reduced X85 (600:7), as in comparison only 7 distinct distances for which 7 distance audio signals are to be determined, or 14 distance audio signals if two distance audio signals are determined for each distinct distance, in order to ensure the desired smoothness of the reverberation;

while at the same time, keeping those distance values to generate the reverberation audio signal that contain the essential information unique to a shape of the virtual object.

In the embodiment of FIG. 10, a straight-forward distribution of the obtained 7 distinct distances to each of the 25 points with an associated distance to the delay time, would result in:

25(xΔt₁)+25(xΔt₂)+25(xΔt₃)+24(xΔt₄)+24(xΔt5)+16(xΔt6)+12(xΔt₇)=151 signal paths

for the distance audio signals to form a sum audio signal for each associated virtual point.

Instead, by comprising virtual points in the symmetry group and associating the distance audio signals with the symmetry groups instead of directly to each virtual point, the number of signal paths needed can be further reduced.

6(xΔt₁)+6(xΔt₂)+6(xΔt₃)+5(xΔt₄)+5(xΔt₅)+3(xΔ₆)+2(xΔ₇)=33 signal paths+4(xg₁)+8(xg₂)+4(xg₃)+4(xg₄)+4(xg₅)+4(xg₆)=61 signal paths

Thus, the amount of signal paths required for the reverberation is further reduced X2.5 (151:61) by introducing the intermediate step of summing the distance audio signals for the symmetry groups, as described in FIG. 10, without any loss of quality/information in the resulting signal after the operation.

The methods described herein thus comprise an efficient solution to optimize the computation power required by using the minimum of processing data and signal paths, and a novel way to satisfy the known criteria for density and smoothness of a high-quality reverberation signal, while introducing new qualities to the reverberation signal with regards to representing its shape and materiality, that are otherwise not attained with methods to produce artificial reverberation known-in-the-art.

It may be understood from the above, that as the virtual point resolution, i.e. the number of defined points per shape, increases, the amount of distinct distances in the further set of one or more distances within the reverb operation 18 also increases, and more distance audio signals are to be generated. This in turn increases the density of the reverb; that is, the ‘time density’ comprising the amount of echoes per second; and, the ‘modal density’ which relates to the amount of frequencies F(f₁, f₂, f₃, etc.) across a frequency range, where each unique F is regarded the result of delay times Δt which are not integer multiples of each other.

The invention further comprises a novel way to optimise the modal density of a reverberation which has a virtual shape, by a balanced distribution of the polar opposites (+/−) of a particular distance r_{n<->n}.

It is known that an inverted and time-delayed feedback signal amplifies the odd harmonics of F(f₁, f₃, f₅, etc.) on the basis of the time delay Δt, and an non-inverted time-delayed signal with feedback amplifies the even harmonics of the same F(f₂, f₄, f₆, etc.) on the basis of the same time delay. Thus, by distributing the signal as symmetrical polar opposites, the even and odd harmonics of the one-and-the-same harmonic series, which are a resulting resonance components of the shape of a reverberating space, the modal density of the resulting reverberation increases two-fold for the same number of distances to be found for the same virtual point resolution of a shape.

In an embodiment, the virtual object is a square plate having four virtual points and therefore one symmetry group. There are two symmetry group distances for this one symmetry group. For each symmetry group distance two distance audio signals are determined, an inverted version and a non-inverted version.

As several perpendicular or parallel distances of the same length may connect one single point, a chess-board like distribution of the polar signs is proposed to achieve optimal symmetrical spreading of polar opposites throughout the complexity of points on a shape, as also described with reference to FIG. 6B.

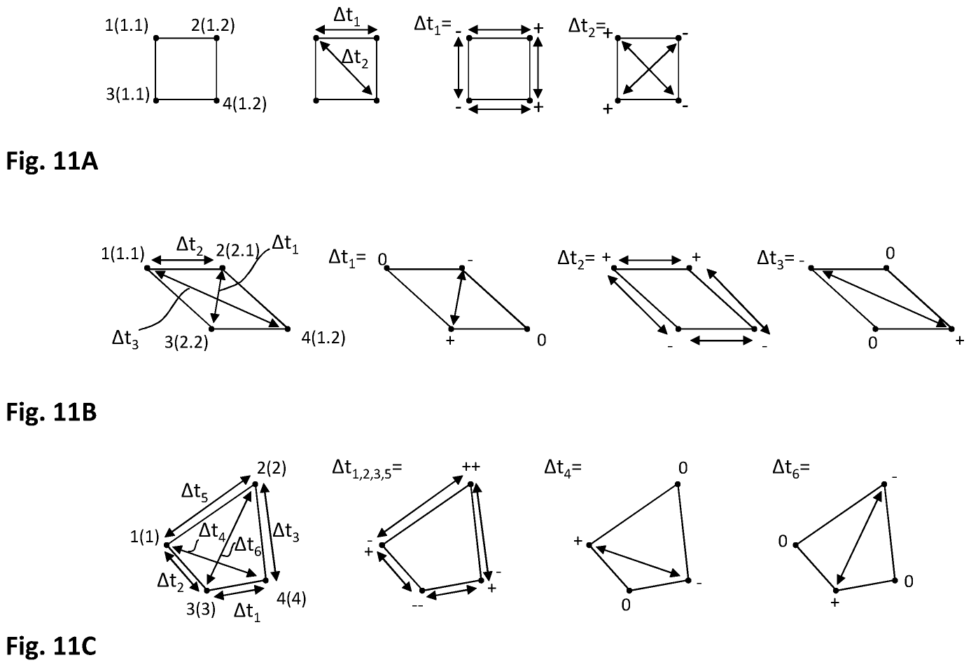

In an embodiment according to FIG. 11A this gives the symmetry group audio signals as shown in the below table. Each row in this table relates to a distinct distance in the further set of one or more distances. In the column, the distances are indicated by associated time delays. Further, each column relates to a symmetry group signal.

Groups (g)

| Δt (ms) | 1.1 | 1.2 |
|---|---|---|
| Δt1 | −1 | +1 |
| Δt2 | +1 | −1 |

Hence, for determining the symmetry group audio signal for symmetry group 1.1, the inverted version of the distance audio signal for distance Δt1 and the non-inverted version of the distance audio signal for distance Δt2 are added together. Further for determining the symmetry group audio signal for symmetry group 1.2, the non-inverted version of the distance audio signal for distance Δt1 and the inverted version of the distance audio signal for distance Δt2 are added together.

In an embodiment, a shape is a plate of equal edges but of unequal length and width, with four virtual points and two symmetry groups. Three distinct distances are found in the further set of one or more distances and for each distinct distance, two distance audio signals are determined. The equal distribution across polar opposites of distance r_{n-<->n+} according to FIG. 11B gives

| | Groups (g) | | | |
|---|---|---|---|---|
| Δt (ms) | 1.1 | 1.2 | 2.1 | 2.2 |
| Δt1 | 0 | 0 | −1 | +1 |
| Δt2 | +1 | −1 | +1 | −1 |
| Δt3 | −1 | +1 | 0 | 0 |

In an embodiment, a shape is a plate with unequal sides, length and width, with four virtual points and four symmetry groups. In this example, each virtual point defined on the shape is its own symmetry group. As such, a symmetry group has only one version of itself instead of two. Six unique distances are found in the further set of one or more distances. The equal distribution across polar opposites of distance r_{n-<->n+} according to FIG. 11C gives

| | Groups (g) | | | |
|---|---|---|---|---|
| Δt (ms) | 1 | 2 | 3 | 4 |
| Δt1 | 0 | 0 | −1 | +1 |
| Δt2 | +1 | 0 | −1 | 0 |
| Δt3 | 0 | +1 | 0 | −1 |
| Δt4 | +1 | 0 | 0 | −1 |
| Δt5 | −1 | +1 | 0 | 0 |
| Δt6 | 0 | −1 | +1 | 0 |

It should be noted that in this embodiment, the distribution deviates from a straight forward chess-board like fashion for Δt2->g3 and Δt3->g4 as the only symmetrical opposites are between the groups rather than points contained within one-and-the-same group.

FIG. 12 is a flow process for a ‘value filter’ operation 34 to obtain the desired time delays in dependence of the distances between virtual points, as described in FIG. 9; and, a ‘time density scaler’ operation 36 to automate optimizing of the required time density of the reverberation based on a variable threshold. The steps until the step “determine symmetry groups” may be performed in the value filter operation 34 and the steps following this step in each iteration may be performed in the time density scaler operation 36.

In particular, the step to determine positions of virtual points may involve receiving a lattice and shape data. The output of this step is an NxN-dimensional array where each element holds distance values of the virtual point to all other virtual points.

The ordering logic of the generated virtual points constitutes a right-handed coordinate system.

const{virtual points}=pd.get virtual points Distances( )

The virtual point numbering and coordinates (x, y, z) relating to the virtual point positions in a virtual space may be generated from a custom shape script file. A simple virtual object script file includes a method where vec3 objects are specified.

```
# . . .
def getPositions(self, density, hollow, speedAdjustedTime):
  positions = [ ]
  #pyramid base 50×50
  positions.append(nap.vec3(−25., 0., −25.))
  positions.append(nap.vec3(0., 0., −25.))
  positions.append(nap.vec3( 25., 0., −25.))
  # . . .
  positions.append(nap.vec3(12.5, 17.67767, 12.5))
  positions.append(nap.vec3(0., 35.355339, 0.))
  return positions
# . . .
```

A computer program may then extract the values in the function call and generate the virtual point coordinates.

```
const config = {
  type: “scriptFile”,
  name: “pyramid”
  fileName: “scripts/pyramidShape”
}
```

const pd2=new virtual points Distances( )

In the next step, distances are calculated between each pair of virtual points. As each virtual point has an (x, y, z) coordinate, the standard distance formula is used

r=√((x2−x1)²+(y2−y1)²+(z2− z1)²)

After that, delay times are converted from the distances based on receiving the value for speed of sound (v). For a virtual object having N virtual points, the result is a N×N-dimensional matrix where entry eᵢⱼ is the delay time Δt(ms) between virtual points pᵢ and pⱼ. In the case of a 1×1 meter plate with 3×3 virtual points equally distributed on its surface this gives

| | P1 | P2 | P3 | P4 | P5 | P6 | P7 | P8 | P9 |
|---|---|---|---|---|---|---|---|---|---|
| 1 | 0 | 0.9718 | 1.9436 | 0.9718 | 1.3743 | 2.1730 | 1.9436 | 2.1730 | 2.7487 |
| 2 | 0.9718 | 0 | 0.9718 | 1.3743 | 0.9718 | 1.3743 | 2.1730 | 1.9436 | 2.1730 |
| 3 | 1.9436 | 0.9718 | 0 | 2.1730 | 1.3743 | 0.9718 | 2.7487 | 2.1730 | 1.9436 |
| 4 | 0.9718 | 1.3743 | 2.1730 | 0 | 0.9718 | 1.9436 | 0.9718 | 1.3743 | 2.1730 |
| 5 | 1.3743 | 0.9718 | 1.3743 | 0.9718 | 0 | 0.9718 | 1.3743 | 0.9718 | 1.3743 |
| 6 | 2.1730 | 1.3743 | 0.9718 | [symbol] | 0.9718 | 0 | 2.1730 | 1.3743 | 0.9718 |
| 7 | 1.9436 | 2.1730 | 2.7487 | 0.9718 | 1.3743 | 2.1730 | 0 | 0.9718 | 1.9436 |
| 8 | 2.1730 | 1.9436 | 2.1730 | 1.3743 | 0.9718 | 1.3743 | 0.9718 | 0 | 0.9718 |
| 9 | 2.7487 | 2.1730 | 1.9436 | 2.1730 | 1.3743 | 0.9718 | 1.9436 | 0.9718 | 0 |

This initial matrix can be obtained by, for each virtual point out of the plurality of virtual points, defining a set of one or more virtual distances comprising the respective virtual distances between the virtual point in question and the respective other virtual points out of the plurality of virtual points. In this example, the set of one or more virtual distances associated with virtual point #1 are indicated on row “1”, the set of one or more virtual distances associated with virtual point #2 are indicated on row “2”, et cetera.

The initial matrix is then passed through a multiplicity filter to remove some of the delay times. The filters may be applied per virtual point, where one virtual point is represented by each horizontal row in the matrix. As some of the generated time delay values might be in proximity of each other, equality is determined by taking the absolute value of the difference of the delay times and checking if the difference is less than the time of one sample, according to sample rate. Such almost identical distances are thus not treated as distinct distances.

function equals(a, b, sampleRate) {
return Math.abs(a −b) < (1/sampleRate)
}

| | P1 | P2 | P3 | P4 | P5 | P6 | P7 | P8 | P9 |
|---|---|---|---|---|---|---|---|---|---|
| 1 | — | 0.9718 | — | — | 1.3743 | 2.173 | — | — | — |
| 2 | 0.9718 | — | — | 1.3743 | — | — | 2.173 | — | — |
| 3 | — | 0.9718 | — | 2.173 | 1.3743 | — | — | — | — |
| 4 | 0.9718 | 1.3743 | 2.173 | — | — | — | — | — | — |
| 5 | 1.3743 | 0.9718 | — | — | — | — | — | — | — |
| 6 | 2.173 | 1.3743 | 0.9718 | — | — | — | — | — | — |
| 7 | 1 | 2.173 | — | 0.9718 | 1.3743 | — | — | — | — |
| 8 | 2.173 | — | — | 1.3743 | 0.9718 | — | — | — | — |
| 9 | — | 2.173 | — | — | 1.3743 | 0.9718 | — | — | — |

In a first instance of the filter applied to a virtual point, we are only interested in the first occurrence of the delay time and all duplicates are filtered out. In the example, the distance between virtual point p1 and virtual point p4 is filtered out as it is the same as the distance between virtual point 1 and virtual point 2. Note that the virtual distance between point 1 and point 2 is kept.

In the second instance of the filter, delay times, i.e. distances, that are integer multiples of other delay times are filtered out as well. In the example, the distance between virtual point p1 and virtual point p3 is filtered out as it is twice the value of the distance between virtual point p1 and virtual point p2

After this filtering step, a virtual point specific set of one or more distances is obtained for each virtual point.

Such virtual point specific set may also be arrived at by first, for each set of one or more distances associated with a virtual point, i.e. for each row in the initial matrix, removing distances that are integer multiples of any other distance in the set, i.e. row in question, to obtain a further set of one or more distances associated with the virtual point. The virtual-point specific set may then be determined as the distinct distances in each further set. To illustrate, the virtual point specific set for point 1 then comprises 0.972, 1.374 and 2.173.

After obtaining the delay times per virtual point that satisfy the filter, the value set of the matrix sorts the distinct delay times, i.e. the distinct distances, in ascending order from shortest to longest delay line. These distinct delay times are also referred to herein as the distinct distances of the further set of one or more distances. After these distinct distances have been found, other characteristics may be analyzed such as the occurrence of the delay time associated with a distinct distance per symmetry group.

The virtual points having the same virtual point specific sets of distances are determined to belong to a symmetry group. To illustrate, point 3 has as virtual point specific set of distances: 0.972, 1.374 and 2.173, which is the same as the virtual point specific set for point 1. Therefore, point 1 and 3 belong to the same symmetry group.

In the example, the time delay of 0.972 ms (i.e. virtual distance 0.333 m) is associated with two symmetry groups, namely symmetry group 1, consisting of virtual points 1−, 2+, 3−, 4+, 6−, 7+, 8−, 9+and symmetry group 2 consisting of virtual point 5−,

the time delay of 1.374 ms (i.e. virtual distance 0.471 m) is associated with two symmetry groups, namely symmetry group 1, consisting of virtual points 1+, 2−, 3+, 4−, 6+, 7−, 8+, 9− and symmetry group 2, consisting of virtual point 5+,

the time delay of 2.173 ms (i.e. virtual distance 0.745 m) is associated with one symmetry group, namely symmetry group 1, consisting of virtual points 1−, 2+, 3−, 4+, 6−, 7+, 8−, 9+.

A new matrix is created where on the horizontal axis all symmetry groups are placed in two versions 1.1 1.2 2.1 2.2 3.1 3.2 etc. If a group consists of only 1 virtual point, there is only one version of the group, and thus the group only appears once in the matrix. On the vertical axis all the distinct distances in the further set of one or more distances formed by all symmetry group distances, which distinct distances are expressed as delay times, are sorted from shortest (top) to longest (down). The polar opposites (+/−) are then added to the matrix in a straight-forward chess-board like fashion. Finally, the virtual points within each symmetry group are distributed alternating between group n.1 and n.2 according to the process as described in FIGS. 11A-C.

The second step of the command chain comprises the ‘time density scaler’ operation, referring to building block 36 in FIG. 3. The time density value for a symmetry group of virtual points may be performed as follows. Each symmetry group of virtual points is associated with one or more symmetry group distances. Further, for each symmetry group distance, one or more distance audio signals are determined using a time delay operation (see 64/72 in FIG. 6A). The time density value, also referred to as the density index, for a specific symmetry group is given by

di=Σ{1/Δt₁,1/Δt₂, . . . ,1/Δt_{Q}}

wherein Δt₁ is the time delay (in seconds) introduced by the time delay operation for determining the one or more distance audio signals for a first distance out of the symmetry group distance, Δt₂ is the time delay introduced by the time delay operation for determining the one or more distance audio signals for a second distance out of the symmetry group distance, et cetera. Q denotes the number of symmetry group distances for the symmetry group for which the density index is determined.

The given time density per symmetry group is compared to a variable threshold. If the calculated value for di is lower than the threshold, it does not satisfy the filter and commands the process to increase the virtual point resolution and triggers a rerun of the command chain until the density index for each symmetry group is equal to or higher than the threshold, and thus satisfies the filter.

The amount of echoes per second to satisfy enough density of the reverberation is generally considered to be a 1000 s⁻¹ but may be as high as 10000 s⁻¹, depending on the type and character of the audio input signal to the audio signal process. The real di is further influenced by the summation of all audio output signals in the loudspeakers as described in FIG. 6C; and, by the amount of generated virtual point audio signal components in the first reflections operation 12 which will increase the real di x_{N} (=number of delay lines in 12). Thus, the time density threshold is required to be a variable parameter that may be adjusted by a user dependent on various circumstances.

In this way, a system for generating reverberation in a virtual object adjusts automatically to the most optimal density condition for a given virtual object in a given condition. In prior-art application of artificial reverberation systems, parameters such as delay times are carefully chosen to satisfy criteria of time density. The invention provides a novel way to require optimal time density without pre-requiring a fixed set of values, such as the chosen delay times in a system, and where instead, such values may depend on the attributes of a shape, i.e. reverberation in a virtual object with a dimensional shape, size and materiality.

FIG. 13 illustrates a flow process for a ‘sample rate interpolator’ operation 32 to obtain desired low-pass filtering included in the first reflections operation 12 and the reverb operation 18; specifically in the case of high and ultra-high frequency cut-off values f_{c} that may occur in dependence of set conditions of a reverberation, including the speed of sound travelling through a medium, the temperature, humidity and other factors; and, in dependence of the size and the virtual point resolution of a virtual object, which determines the scale of the distances between the virtual points. The obtained values f_{c} as part of a delay line either executed in the first reflections operations 12 or reverb operations 18 may be (far) above the threshold of the human audible frequency range (˜20 kHz), and more specifically, may be larger than the Nyquist frequency (=0.5×sample rate).

The Nyquist frequency practically determines the upper threshold of the assignable cut-off frequency in a digital low-pass filter, which means filtering above the Nyquist will not yield an audible effect. Nevertheless, the effect of the distance-dependent damping function as described in FIG. 6A, and which may involve a value for f_{c} above the Nyquist frequency, may also imply a significant audible effect from the attenuation of frequencies below the Nyquist frequency. As an approach to optimise the damping function in the first reflection and reverb operations, a command flow is proposed that takes into account the relation of the sample rate of the audio output device connected to (or as part of) the computer processing unit running a programme or code portion and the generated frequency cut-off values in first reflection operations 12 and reverb 18, by locally increasing the sample rate to complete the desired filtering operation, and then decreasing the sample rate back to the sample rate of the audio output device, by means of sample interpolation.

As a first step all required distances are calculated between the input source and each virtual point in the case of the first reflections operation; or, between all virtual points in the case of the reverb operation, as described in FIG. 12. The f_{c} may then be determined as described in detail in FIG. 6A with reference to operation 54.

A second step comprises a first filter to determine if further action is required with regards to sample interpolation. If the obtained value for f_{c} is larger than the Nyquist frequency it does not satisfy the filter, which commands the process to locally increase the sample rate by interpolation until it satisfies the filter and commands to perform the low-pass filtering process at the locally optimised sample rate.

After the low-pass filtering operation has been completed, a second filter checks if the local sample rate matches the sample rate of the audio output device and if it does not satisfy the filter, it decreases the local sample rate by interpolation until the sample matches the sample rate of the audio output device.

As a result, even though the frequency cut-off in question may be (far) above the human hearing range, the effects of the frequency cut-off on frequencies within human audible range will be accurately encoded in the signal after the sample interpolation. The applicant has found out that this has a significant effect on the accuracy and smoothness of the high-frequency dissipation constituted in the reverberation audio signal as described.

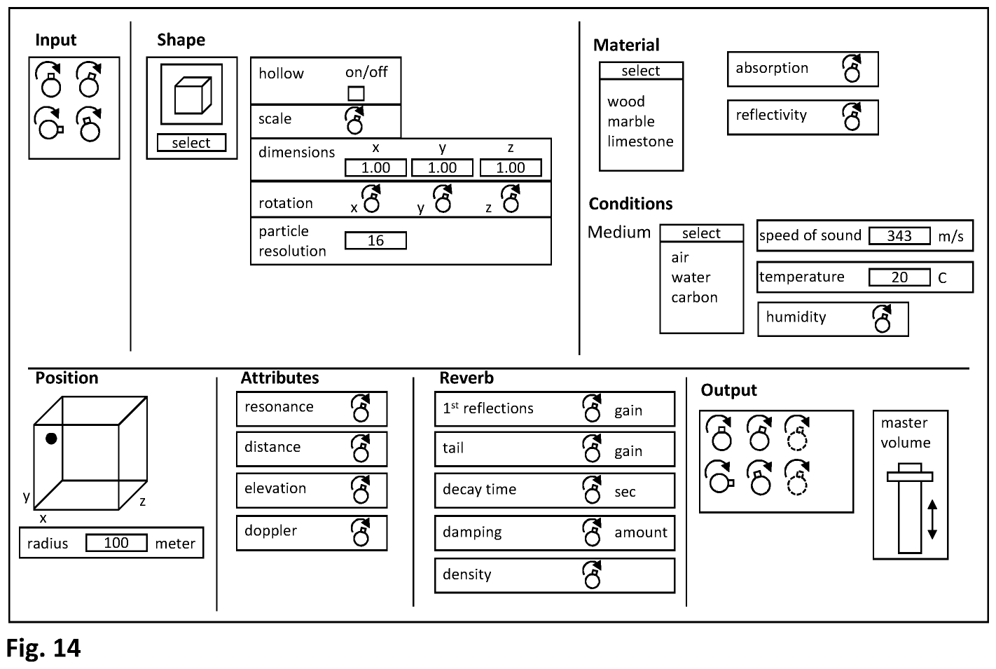

FIG. 14 depicts a user interface according to an embodiment of the invention. An embodiment of the method comprises generating a user interface as described herein.

In an embodiment, a user interface for the described system comprises a module to control the virtual object, e.g. its position with respect to an observer and/or “vantage-point”, the shape of the virtual object, the material of which the virtual object consists, the conditions of the selected medium for sound propagation, the attributes of the reverb itself, several other attributes such as the resonance resulting from standing waves within the virtual object of a particular shape, and the audio output of the audio signal process, which may include a master output level, as well as send levels for an audio output signal, or “audio mix-down”, from the audio signal process to provide as an input audio signal to other audio signal processes determined for other virtual objects.

The depicted user interface comprises an input section that enables a user to control the audio output signal or audio mix-down from other audio signal processes determined for other virtual objects as an input audio signal for the audio signal process determined for said virtual object using input channels. The input channels may comprise of multiple audio channels, either receiving an audio signal from an audio signal process determined for another virtual object, optionally by performing a method as described, or external audio sources, together combined as the input audio signal for the audio signal process determined for said virtual object. The user interface enables a user to control the amplification of each input channel, e.g. by using gain knobs.

The user interface may further comprise an output section that enables a user to route the summed audio output signals, or audio mix-down, of the audio signal process determined for said virtual object as an input audio signal to determine audio signal processes for other virtual objects.

The output module may further comprise a master level fader, which may determine the level of the optional attenuation (value ‘a’) of the audio output signals of the audio signal process fed to discrete loudspeakers, such as described in FIG. 5.

The user interface may further comprise a virtual object definition section that enables a user to input parameters relating to the virtual object, such as its shape, e.g. selecting a shape by means of a drop-down menu; and/or whether the virtual object is hollow or solid by means of an on/off button; and/or adjusting the scale, i.e. the size of the virtual object by means of a knob; and/or its dimensions, e.g. its Cartesian dimensions by means of number boxes for dimensions x, y and z; and/or a rotation; and/or a resolution to determine the amount, i.e. the density, of virtual points defined on the shape of the virtual object by means of a number box. This allows a user to control the amount of required calculations in the audio signal process determined for the virtual object.

The input means for inputting parameters relating to rotation may be presented as endless rotational knobs for dimensions x, y and z

The user interface may further comprise a position section that enables a user to input parameters relating to the position of the virtual object. The position of the shape in 3-dimensional space may be expressed in Cartesian coordinates +/−x, y, z wherein the virtual center of the space is denoted as 0, 0, 0; and which may be presented as a visual 3-dimensional field that one can place and move a virtual object within. This 3-dimensional control field may be scaled in size by adjusting the radius of the field.

The discrete audio output signals for each loudspeaker resulting from the reverberation audio signal process determined for the virtual object, may thus be automatically controlled by i) the modelling of the virtual object's shape, ii) the rotation of the shape in 3-dimensional space and iii) the position of the shape in 3-dimensional space.

The user interface may further comprise an attributes section that enables a user to control various parameters, such as a knob to adjust the bandwidth and amount of resonance which determines the attenuation of the optional feedback signal (value ‘b’) in the resonance operation 20 as described in FIG. 16A; a knob for scaling the perceived distance, which determines the multiplication factor x in the formula determining attenuation operation of the distance operation 26 as described in FIG. 16D; a knob for scaling the perceived elevation, which determines the multiplication factor x in the formula determining attenuation operation of either the depth operation 22 as described in FIG. 16B or the height operation 26 as described in FIG. 16C; and, a knob for scaling the amount of Doppler effect, which is a scaler to modify the formula determining the second time delay of the distance operation 26 as described in FIG. 16D.

The user interface may further comprise a section to select a material for the virtual object by means of a drop-down menu with several pre-programmed options.

The choice of material in turn determines a chosen set of ISO354 values in the absorption filter operations as described in FIG. 6A. An ‘absorption knob’ and a ‘reflectivity knob’ provide proportional scalers of the absorption coefficients from the chosen ISO354 values, to increase the absorption characteristic of the chosen material; or, to decreases the absorption characteristic of the chosen material, so that the resulting reflections and reverberation will constitute less absorption and more dense reflections of the sound.

The user interface may further comprise a section to control the conditions of a chosen medium by means of a drop-down menu with several pre-programmed options. The selection of a medium, which in an embodiment may be air, may constitute several custom options specific to the medium which are considered parameters of behaviour of sound propagating in the particular medium, such as in the case of the medium of air, a number box to set the value in C of the temperature and a knob to increase/decrease the humidity. The speed of sound is a resulting value from the choice of medium and related parameters, but may be manually adjusted in a controllable number box to deviate from the calculated standard. The set parameter values in the conditions section determine the frequency-dependent attenuation of the low-pass filter operations and determine the time delays in the time delay operations of the first reflections operations 12 and reverb operations 18 as described in FIG. 6A; determine the calculations of the time delays in the value filtering operation as described in FIG. 12; and, determine the frequency cut-off in relation to the Nyquist frequency as described in FIG. 13.

The user interface may further comprise a section to control attributes of the reverb, such as a knob for controlling the output gain of the first reflections, which determines the level of the optional attenuation (value ‘a’) of the audio signal components resulting from the first reflections operation 12 as described in FIG. 6C; a knob for controlling the output gain of the reverb tail, which determines the level of the optional attenuation (value ‘b’) of the audio signal components resulting from the reverb operation 18 as described in FIG. 6C; a knob for controlling the decay time of the reverb, which determines the coefficient x in the formula determining attenuation operation of the reverb operation 18 as described in FIG. 6A; a knob for controlling the damping of the reverb, which may modify and/or scale the coefficient y in the formula determining the frequency cut-off in low-pass filtering operation as part of the first reflections 12 and/or reverb operation 18 and to further modify, that is increase or decrease the effect of the correction formula for high-frequency dissipation used in the attenuation operation of the reverb operation 18 as described in FIG. 6A; and, a knob for controlling the density of the reverb, which sets the time density threshold used to automate adjustment to the optimal time density of the reverberation system, as described in FIG. 12.

The user input that is received through the user interface may be used to determine appropriate values for the parameters according to methods described herein. All functional operations of the reverberation system are thus translated to front-end user properties, i.e. audible manipulations of sound sources reverberating in a virtual space with a dimensional shape, size and materiality.

It should be understood that the application of the invention is in no way limited to the lay-out and of this particular interface example and can be the subject of numerous approaches in system design and involve numerous levels of control for shaping and positioning sound sources in a virtual space, nor is it limited to any particular platform, medium or visual design and/or layout.

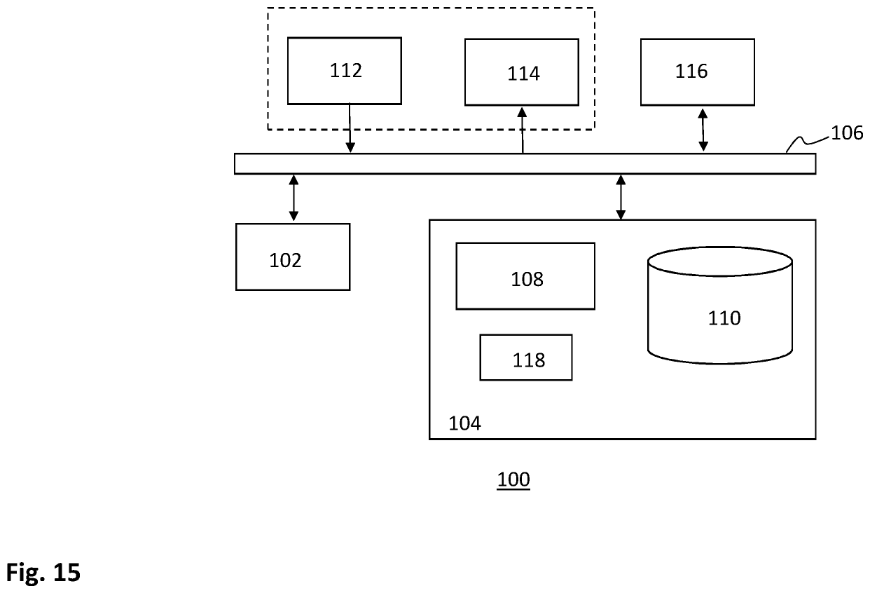

FIG. 15 depicts a block diagram illustrating a data processing system according to an embodiment.

As shown in FIG. 15, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 15 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 15, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 15) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a first reflections module 12 and/or absorption filter 16 and/or reverb module 18 and/or resonance module 20 and/or depth module 22 and/or height module 24 and/or distance module 26 and/or panning system 28 as described herein.

Furthermore, the data processing system 100 may represent a shape generator and/or sample rate interpolator 32 and/or value filter 34 and/or time density scaler 36 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

The inventor acknowledges la Mgvdliashvili and Dr. Amira Val Baker for their contributions to this disclosure.

1. A method for generating a reverberation audio signal associated with a virtual object, the method comprising
storing a representation of the virtual object, the representation defining a plurality of virtual points constituting the virtual object, wherein the virtual points have respective virtual positions with respect to each other, and wherein the virtual points belong to symmetry groups of virtual points, wherein the symmetry groups of virtual points are obtainable by
for each virtual point out of the plurality of virtual points, defining a set of one or more virtual distances comprising the respective virtual distances between the virtual point in question and the respective other virtual points out of the plurality of virtual points, and
for each set of one or more distances associated with a virtual point, removing distances that are integer multiples of any other distance in the set to obtain a further set of one or more distances associated with the virtual point; and
for each further set of one more distances associated with a virtual point, determining distinct distances in the further set in question to form a virtual point specific set of one or more distances associated with the virtual point; and
determining virtual points that have the same respective virtual point specific sets of one or more distances to form a symmetry group of virtual points, the symmetry group of virtual points thus being associated with a set of one or more symmetry group distances that is the same as the virtual point specific sets of its virtual points; wherein
the sets of one or more symmetry group distances which sets are respectively associated with symmetry groups, together form a further set of one or more distances,
the method further comprising
receiving and/or storing and/or generating an input audio signal, and
for each virtual point, determining, based on the input audio signal, or filtered version thereof, a virtual point audio signal component, and
combining the thus obtained virtual point audio signal components to obtain a composite audio signal, and
determining for each distinct distance in the further set of one or more distances, based on the composite audio signal, one or more distance audio signals,
determining the reverberation audio signal based on the one or more distance audio signals and the virtual point audio signal components.

2. The method according to claim 1, further comprising
determining for each symmetry group, based on the determined distance audio signals, one or more symmetry group audio signals, and
determining the reverberation audio signal based on the symmetry group audio signals and the virtual point audio signal components.

3. The method according to claim 1, wherein determining a virtual point audio signal component for each virtual point based on the input audio signal, or filtered version thereof, comprises
for each virtual point, performing a virtual-point-specific operation on the input audio signal, or modified version thereof, wherein performing the virtual point specific operation comprises performing a time delay operation introducing a time delay, wherein the introduced time delay is approximately equal to a virtual distance between the virtual point in question and a virtual sound source divided by a speed of sound.

4. The method according to claim 1, wherein determining for each distinct distance in the further set of one or more distances, one or more distance audio signals comprises
determining for each distinct distance in the further set of one or more distances, a first distance audio signal and a second distance audio signal, wherein
determining the first distance audio signal for a distinct distance comprises modifying the composite audio signal by performing a time delay operation introducing a time delay, a signal attenuation operation, a low-pass filter operation and a signal feedback operation, and wherein
determining the second distance audio signal for the distinct distance comprises modifying the composite audio signal by performing a second time delay operation introducing a second time delay, a signal inverting operation, a signal attenuation operation, a low-pass filter operation and a second signal feedback operation.

5. The method according to claim 4, wherein the time delay introduced by the first time delay operation is equal to the distinct distance divided by a speed of sound.

6. The method according to claim 5, and further comprising
determining for each symmetry group, based on the determined distance audio signals, one or more symmetry group audio signals,
determining the reverberation audio signal based on the symmetry group audio signals and the virtual point audio signal components,
and wherein determining for each symmetry group, based on the distance audio signals, one or more symmetry group audio signals comprises
determining, for each symmetry group, a first symmetry group audio signal and a second symmetry group audio signal, wherein
determining the first and second symmetry group audio signals comprises, selecting a distance audio signal out of every pair of first and second distance audio signal, each pair having been determined for a respective distance out of the set of one or more symmetry group distances associated with the symmetry group in question, and combining the selected distance audio signals in order to determine the first symmetry group audio signal and combining the non-selected distance audio signals out of every said pair of first and second distance audio signal in order to determine the second symmetry group audio signal.

7. The method according to claim 2, wherein determining the audio signal based on the symmetry group audio signals and the virtual point audio signal components comprises
combining the symmetry group audio signals with the virtual point audio signal components to determine said reverberation audio signal, wherein
combining the symmetry group audio signals with the virtual point audio signal components to determine said audio signal comprises
determining modified audio signal components, wherein determining modified audio signal components comprises adding, to each virtual point audio signal component determined for a virtual point belonging to a symmetry group, the first or second symmetry group audio signal of the symmetry group in question.

8. The method according to claim 1, further comprising generating a further reverberation audio signal for a further virtual object, wherein
the determined reverberation audio signal associated with the virtual object is used as input audio signal.

9. The method according to claim 8, further comprising combining the reverberation audio signal associated with the virtual object and the further reverberation audio signal associated with the further virtual object, and, optionally,
providing the combination to one or more loudspeakers.

10. The method according to claim 1, further comprising providing the determined audio signal to one or more loudspeakers.

11. The method according to claim 7, comprising
providing the modified audio signal components to one or more loudspeakers comprises providing the modified audio signal components to a panning system that is configured to distribute the modified audio signal components to a plurality of loudspeakers.

12. The method according to claim 2, further comprising
filtering the input audio signal before determining, for each virtual point, a virtual point audio signal component, wherein filtering the input audio signal comprises
applying a multi-band filter comprising attenuating respective frequency bands in the input audio signal using respective attenuation coefficients, wherein the respective attenuation coefficients are determined based on a material of the virtual object.

13. The method according to claim 2, wherein determining for each distinct distance in the further set of one or more distances, one or more distance audio signals comprises
determining for each distinct distance in the further set of one or more distances, a distance audio signal comprising modifying the composite audio signal by performing a time delay operation introducing a time delay, a signal attenuation operation, a low-pass filter operation and a signal feedback operation, the method further comprising
determining for at least one symmetry group of virtual points a density index comprising
determining for each distance out of the set of one or more symmetry group distances associated with the at least one symmetry group, how many feedback operations for determining a distance audio signal for the distance in question are performed per unit of time, for example by dividing said unit of time by the time delay introduced by the time delay operation performed for determining the distance audio signal in question, thus obtaining for each distance out of the set of one or more symmetry group distances associated with the at least one symmetry group respective numbers of performed feedback operations, and
adding the respective numbers of performed feedback operations to obtain the density index for the symmetry group of virtual points, the method further comprising
receiving a threshold value for the density index, and
determining that the determined density index is lower than said threshold value, and
based on this determination, changing the stored representation by increasing the number of virtual points that constitute the virtual object.

14. The method according to claim 4, wherein the low pass filter operation comprises
determining that the to be low-pass filtered signal is associated with a Nyquist frequency that is lower than a cut-off frequency associated with the low pass filter operation, and
based on this determination, up-sampling the to be filtered signal so that it is associated with a Nyquist frequency that is higher than or equal to said cut-off frequency, and
low-pass filtering said up-sampled signal, and,
optionally, determining that the filtered signal is associated with a higher sample rate than an output sample rate, wherein the output sample rate is the sample rate that can be output by an output system, and, based on this determination, down-sampling the filtered signal.

15. A computer comprising a
a computer readable storage medium having computer readable program code embodied therewith, and
a processor coupled to the computer readable storage medium, wherein responsive to executing the computer readable program code, the processor is configured to perform the method according to any of the preceding claims.

16. A computer program or suite of computer programs comprising at least one software code portion or a computer program product storing at least one software code portion, the software code portion, when run on a computer system, being configured for executing the method according to claim 1.

17. A non-transitory computer-readable storage medium storing at least one software code portion, the software code portion, when executed or processed by a computer, is configured to perform the method according to claim 1.
